(19) United States
(12) Patent Application Publication
(10) Pub. No.: US 2002/0087450 A1
(43) Pub. Date: Jul. 4, 2002

(54) Venture matching method and system

(76) Inventor: Sada L. Reddy, Suffern, NY (US)

Correspondence Address: Daniel F. Perez, Bickel & Brewer, 4800 Bank One Center, 1717 Main Street, Dallas, TX, 75201, US

(21) Appl. No.: 09/751,365

(22) Filed: Dec. 29, 2000

(51) Int. Cl. G06F 17/60

(52) U.S. Cl. 705/37; 705/1

(57) ABSTRACT

A method and system in a computer network for interactively matching entrepreneurs with investors based on user-provided data, wherein the computer network has at least one client connectable to one or more servers. A database may be designated wherein investor-provided data (606) and entrepreneur-provided data are stored (610). Entrepreneur-provided data and investor-provided data may be then analyzed and reviewed (612). The entrepreneur-provided data may be matched with investor-provided data based on a set of predetermined matching criteria (614), thereby enabling entrepreneurs to match with appropriate investors through a web-based site. Software modules may be provided which prompt users to enter particular investor or entrepreneur data and also to render matching information within the web-based site, in response to matching entrepreneur-provided data with investor-provided data based on a set of predetermined matching criteria.

### FIELD OF THE INVENTION

The present invention is generally related to methods and systems that utilize computer networks to interact with and assist electronic commerce (“E-commerce”) users and customers. The present invention is additionally related to web-based sites that deliver financial and business information to entrepreneurs and investors. In addition, the present invention relates to electronic techniques for enabling the matching of venture financing institutions, organizations and individuals with entrepreneurs.

### BACKGROUND

The development of computerized information resources, such as the “Internet,” and the proliferation of “Web” browsers, permit users of data-processing systems to link to other servers and networks, and thus retrieve vast amounts of electronic information heretofore unavailable in an electronic medium. Such electronic information generally is increasingly displacing more conventional means of information transmission, such as newspapers, magazines, and even television. As a result of this displacement, commercial enterprises and endeavors previously practiced only by conventional means of information transmission, are now being implemented and practiced via the “Internet” and “Web” browsers.

The term “Internet” is an abbreviation of “Internetwork,’ and refers to the collection of networks and gateways that utilize the TCP/IP suite of protocols, which are well known in the art of computer networking. TCP/IP is an acronym for “Transport Control Protocol/Interface Program,” a software protocol originally developed by the Department of Defense for communication between computers, but now primarily utilized as one of a number of standardized Internet communications protocols.

In the last decade of the 20^{th} century, explosive growth occurred in the use of the globally-linked network of computers now known as the “Internet.” In particular, the World Wide Web, or simply the “Web,” which facilitates the use of the Internet, has resulted in a revolution of electronic commerce and information transmission. The World Wide Web, well known in the Internet and computer networking arts, is generally composed of many pages or files of information distributed across a variety of computer servers and systems.

In order to utilize the World Wide Web, a client computer system runs a portion of software known as a graphical “Web” browser, such as Netscape Navigator or Internet Explorer. “Netscape” and “Navigator” are trademarks of the Netscape Communications Corporation, while “Internet Explorer” is a trademark of Microsoft. The client computer system interacts with the browser to select a particular Universal Resource Locator (URL), by which each page is identified. The URL denotes both the server machine, and the particular file or page on that machine. Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page can be then displayed for the user to view on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical browser as well as formatting commands which “tell” the browser how to display the data. Thus, a typical “Web” page includes text together with embedded formatting commands, referred to as “tags,” which can be utilized to control the font size, the font style (e.g., italic or bold), textual layout, and so forth. A Web browser “parses” the HTML script in order to display the text in accordance with the specified format. HTML tags are also utilized to indicate how graphics, audio, and video are manifested to the user via the client's browser.

The majority of Web pages also contain one or more references to other Web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page can be retrieved, thereby replacing the currently displayed page.

Commercial enterprises, organizations, and companies are actively utilizing the World Wide Web to initiate commerce. Several phases of electronic commerce via the World Wide Web have taken place. The first phase, namely publicity for companies and organizations, has already occurred. Homepages are commonplace, an essential ingredient for any company which wishes to maintain itself in line with current business practices. The publicity material posted electronically on company homepages contain marketing information, product brands, and in some cases, product catalogues.

The second phase, namely to conduct commerce, is generally emerging. Enterprises are poised to conduct business via the World Wide Web. They are seeking to make sales of their products and services, utilizing the World Wide Web. Software infrastructure is generally coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

The third phase of commercial World Wide Web development, namely, the business-to-business arena, generally is only now being seriously implemented. Web business-to-business solutions require two components. First, a customer must be willing to engage in commercial transactions via the World Wide Web. Second, the company or enterprise expecting customer participation must offer and implement a secure and efficient electronic information delivery system.

A lack of financial, marketing and business development information has prevented investors and entrepreneurs from effectively utilizing the Internet to seek venture financing and thereby initiate new enterprises. Most Web-based sites in existence today directed at entrepreneurs typically are implemented in the form of a series of on-line brochures or catalogues. While adequate at providing basic business and financial information, such sites fail to satisfy customer preferences for investor matching, venture capital funding, and investor/entrepreneur deal making. Such sites also tend to be static. That is, information presented is generally not tailored to the needs and requirements of the entrepreneurs and investors.

Those skilled in the Internet and computer networking arts can thus appreciate, based on the foregoing, that what is needed to attract entrepreneurs and investors to the electronic commercial environment is a Web-based site that targets the needs of entrepreneurs and investors. Such a site, if implemented properly, could provide valuable financial, marketing, and business development information to entrepreneurs and investors, while attracting increasing numbers of entrepreneurs and investors to the electronic commerce environment. In addition, such a web-based site, if implemented correctly, could enable venture financing by bringing together investors and entrepreneurs in an electronic environment, who otherwise may not meet or have access to one another. Additionally, such a web-based site would also allow entrepreneurs to be matched with venture financing organizations and other investors through a systematic matching approach. It is believed that the web-based site method and system described herein meets this increasingly important need.

### SUMMARY

It is one aspect of the present invention to provide an interactive web-based site for a computer network.

It is another aspect of the present invention to provide a web-based site for interactively delivering financial and business information to investors.

It is yet another aspect of the present invention to provide electronic techniques for enabling venture financing for entrepreneurs and investment opportunities for investors.

It is still another aspect of the present invention to provide a method and system for enabling venture financing for entrepreneurs and investment opportunities for investors utilizing a computer network.

It is yet another aspect of the present invention to provide a method and system for matching entrepreneurs with venture financing organizations and investors.

It is yet another aspect of the present invention to provide a method and system for enabling venture matching for entrepreneurs and investors through the use of a computer network.

The above and other aspects of the present invention are achieved as is now described. A method and system in a computer network for interactively matching entrepreneurs with investors based on user-provided data, wherein the computer network has at least one client connectable to one or more servers. A database may be designated wherein investor-provided data and entrepreneur-provided data may be stored. Entrepreneur-provided data and investor-provided data may be analyzed. Finally, entrepreneur-provided data may be matched with investor-provided data based on a set of predetermined matching criteria, thereby enabling entrepreneurs to match with appropriate investors through a web-based site. Modules may be provided which prompt users to enter particular investor or entrepreneur data and also to render matching information within the web-based site, in response to matching entrepreneur-provided data with investor-provided data based on a set of predetermined matching criteria.

### BRIEF DESCRIPTION OF DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention

FIG. 5 illustrates a block diagram of a computer network in which a preferred embodiment of the present invention can be implemented;

FIG. 6 depicts a flow chart of operations illustrative of a method for interactively enabling venture financing for entrepreneurs, from an entrepreneur-perspective, in accordance with a preferred embodiment of the present invention;

FIG. 7 illustrates a flow chart of operations illustrative of a method for interactively enabling venture financing for entrepreneurs, from an investor-perspective, in accordance with a preferred embodiment of the present invention;

FIG. 8 depicts a flow chart of operations illustrative of a method for interactively enabling a customer care resource module, in accordance with a preferred embodiment of the present invention;

FIG. 9 illustrates a flow chart of operations illustrative of operational steps for implementing third-party service provider access to a web-based site, in accordance with a preferred embodiment of the present invention;

FIG. 10 depicts a web-based site diagram illustrating of operations for interactively enabling venture financing for entrepreneurs, in accordance with a preferred embodiment of the present invention;

FIG. 11 illustrates a pictorial diagram illustrating a web-based site homepage, in accordance with a preferred embodiment of the present invention;

FIG. 12 depicts a pictorial diagram illustrating an entrepreneur homepage, in accordance with a preferred embodiment of the present invention;

FIG. 13 illustrates a pictorial diagram illustrating example user input fields for collecting particular entrepreneur data, in accordance with a preferred embodiment of the present invention;

FIG. 14 depicts a pictorial diagram illustrating an entrepreneur-based Quick Match section that can be displayed within a web browser window, in accordance with a preferred embodiment of the present invention;

FIG. 15 illustrates a pictorial diagram illustrating an investor page, in accordance with a preferred embodiment of the present invention;

FIG. 16 depicts a pictorial diagram illustrating a business opportunity search page, in accordance with a preferred embodiment of the present invention;

FIG. 17 illustrates a pictorial diagram illustrating a page having help and feature descriptions for a web-based site, in accordance with a preferred embodiment of the present invention;

FIG. 18 depicts a high-level flow chart of operations illustrating steps for implementing a method for interactively enabling venture matching, in accordance with a preferred embodiment of the present invention;

FIG. 19 illustrates a flow chart of operations illustrating high-level venture matching operations, in accordance with a preferred embodiment of the present invention; and

FIG. 20 depicts of a flow chart of operations illustrating detailed venture matching operations, in accordance with a preferred embodiment of the present invention.

### DESCRIPTION OF PREFERRED EMBODIMENTS

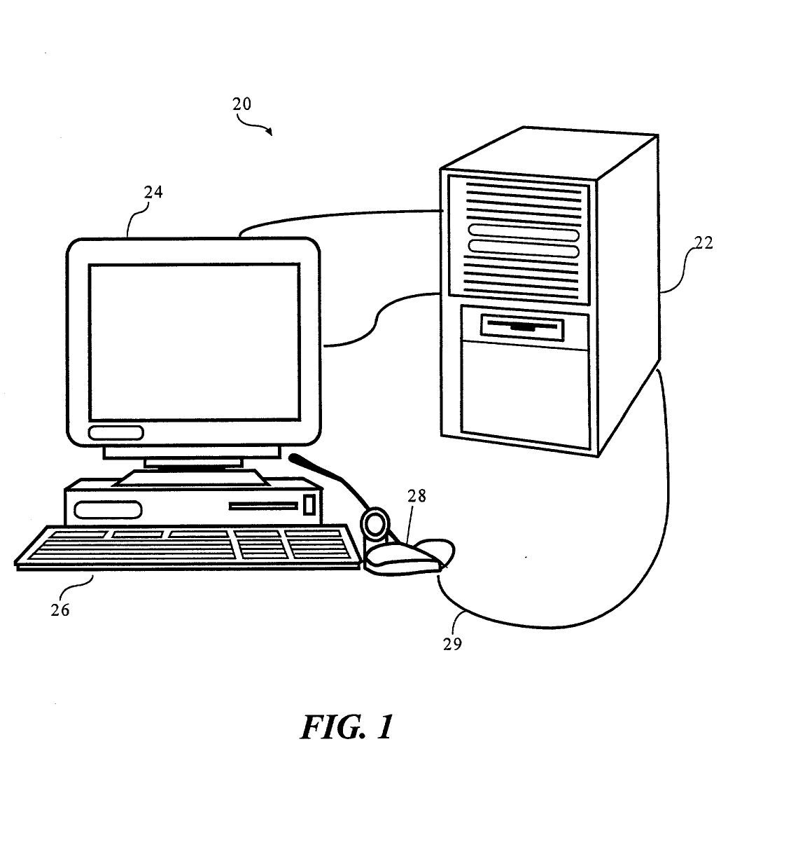

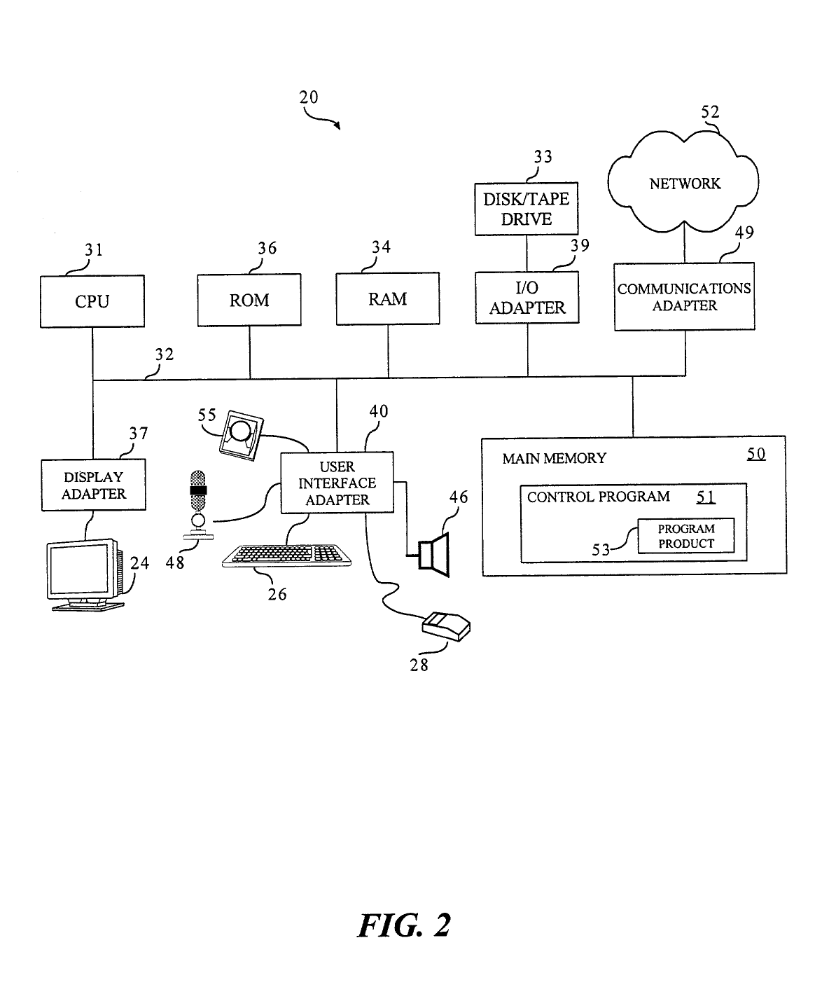

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is generally implemented as a complicated multi-user computing apparatus or a single-user workstation. In FIG. 1 and FIG. 2, like parts are identified by like numbers.

FIG. 2 depicts a representative hardware environment of the computer system of a preferred embodiment of the present invention. Computer system 20 includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

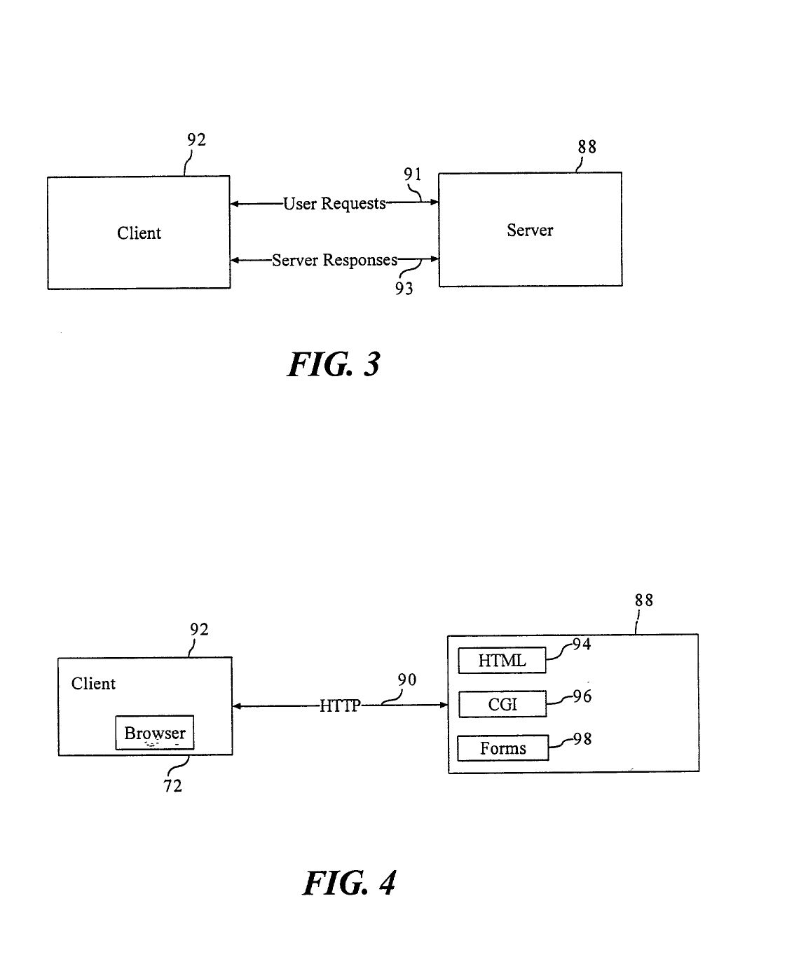

Video display terminal 24 generally provides the visual output of computer system 20. Video display terminal 24 can be implemental as a CRT-based video display, well known in the art of computer hardware. In the context of a portable or notebook-based computer, however, video display terminal 24 can be replaced with a gas plasma-based or LCD-based flat-panel display. Computer system 20 further includes user interface adapter 40 for connecting keyboard 26, mouse 28, speaker 46, microphone 48, and/or other user interface devices, such as a touch-screen device (not shown) or a track-ball device 55 to system bus 32. Communications adapter 49 connects computer system 20 to a network 52, such as a computer network. Such a computer network may be implemented as, for example, the computer network configuration described herein with reference to FIGS. 3 to 5. Although computer system 20 may be shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 may be connected to system bus 32, and includes a control program 51. Control program 51 resides within main memory 50, and contains instructions that, when executed on CPU 31, carries out the operations depicted in the logic flow diagrams described herein. Control program 51 may be implemented as a program product 53, or may include software modules or functions based on program product 53. Such a program product may be implemented as, or may include, signal-bearing media such as recordable media and/or transmission media.

It is important to note that, while the present invention has been (and will continue to be) described in the context of a fully functional computer system, those skilled in the art can appreciate that the present invention may be capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module may be typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation may be private in that it is only accessible by the module. The implementation also contains source code that actually implements the routines in the module. Thus, a program product can be formed from a series of interconnected modules or instruction modules dedicated to working together to accomplish a particular task.

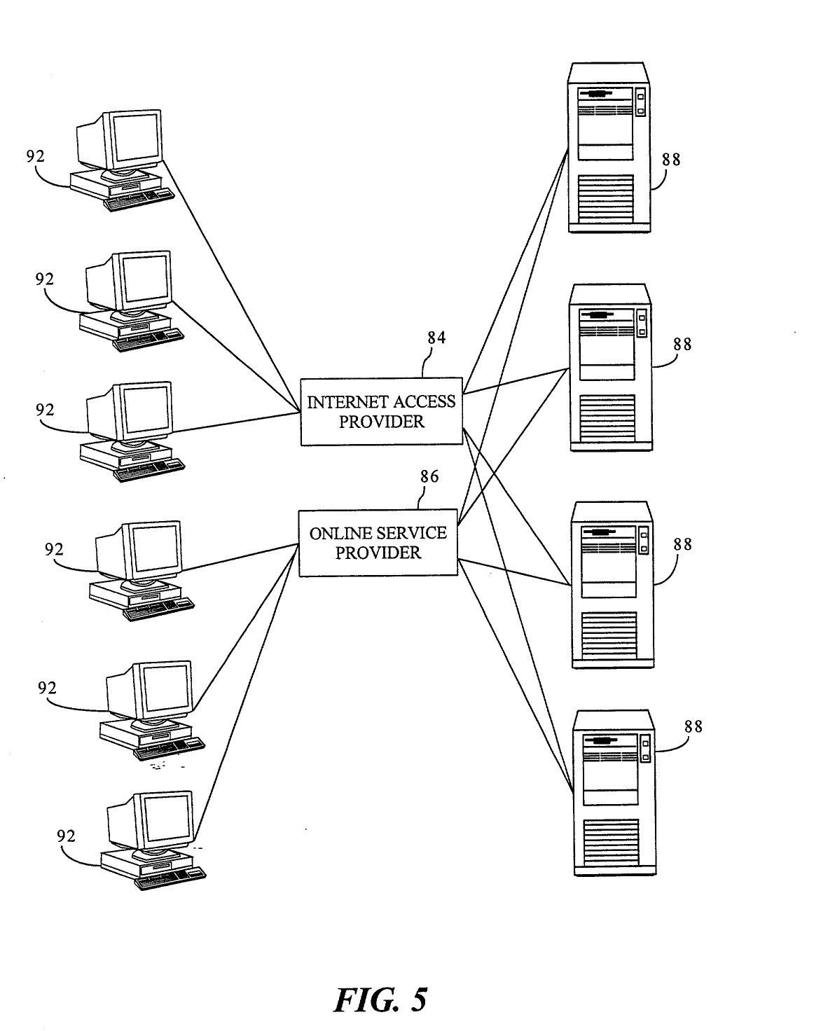

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds or news groups) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which may be interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. For example, the Mosaic-brand browser available from the National Center for Supercomputing Applications (NCSA) in Urbana-Champaign, Ill., can be utilized in accordance with a preferred embodiment of the present invention. Other browsers, such as Netscape™, also provide the functionality specified under HTTP. “Netscape” is a trademark of Netscape, Inc.

Server 88 executes the corresponding server software, which presents information to the client in the form of HTTP responses 90. The HTTP responses 90 correspond with the Web pages represented using HTML, or other data generated by server 88. Server 88 provides HTML 94. With certain browsers, a Common Gateway Interface (CGI) 96 may be also provided, which allows the client program to direct server 88 to commence execution of a specified program contained within server 88. This may include a search engine that scans received information in the server for presentation to the user controlling the client.

By utilizing this interface, and HTTP responses 90, server 88 may notify the client of the results of that execution upon completion. Common Gateway Interface (CGI) 96 may be one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This may be provided by the “fill-in-forms” functionality (i.e., forms 98), that may be provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is representative of the Internet, which can be described as a known computer network based on the client-server model discussed herein. Conceptually, the Internet includes a large network of servers 88 that are accessible by clients 92, typically users of personal computers, through some private Internet access provider 84 (e.g., such as Internet America) or an on-line service provider 86 (e.g., such as America On-Line, Prodigy, Juno, and the like).

Each of the clients 92 may run a browser to access servers 88 via the access providers. Each server 88 operates a so-called “Web site” that supports files in the form of documents and web pages. A network path to servers 88 may be identified by a Universal Resource Locator (URL) having a known syntax for defining a network collection. Computer network 80 can thus be considered a Web-based computer network.

The method and system described herein can be utilized to create an efficient online marketplace and community where entrepreneurs who seek funding are connected with individual investors and/or venture capitalists searching for promising investment opportunities. In addition, the method and system described herein permits entrepreneurs or investors to be connected with service providers who can assist with business services. The method and system described herein can be geared to the many companies and small investors who could be better served by the current, off-line environment.

Thus, the method and system of the present invention implements a virtual world where entrepreneurs, individual investors, venture capitalists, and service providers can come together to facilitate the success of emerging companies. By utilizing a web-based site according to the method and system of the present invention, companies in search of funds can be brought together with angel investors and venture capitalists seeking investment opportunities, all in a one-stop shopping experience.

Access to a full suite of preferred service providers, such as legal services, consulting and executive search capabilities can also be implemented in accordance with a preferred embodiment of the present invention to make such transactions both efficient and convenient. So-called virtual meetings and electronic distribution of documents can also be implemented in accordance with the present invention to streamline the due diligence process and reduce associated heavy travel costs.

By utilizing the method and system of the present invention, the time to obtain money for entrepreneurs can be compressed by several months at a lower cost than available currently. Such a time-saving service permits companies to focus their energy on growing their business, rather than chasing after investment funding. In addition, by utilizing custom services offered online through the web-based site described herein, according to a preferred embodiment of the present invention, investments in early-stage companies may be more attractive to potential investors.

Additionally, venture capitalists and angel investors can enjoy a stronger volume of highly qualified investment opportunities from a reliable source, because potential investment opportunities can be screened against particular selection criteria, according to the method and system described herein. Venture capitalists utilizing a preferred embodiment of the present invention can thus have more time available for due diligence, while angel investors can extend the reach of their potential investment opportunities beyond their local geography.

In a preferred embodiment of the present invention, a web site or web-based site can be implemented as a virtual community of entrepreneurs seeking funding for their emerging businesses and investors searching for these emerging business opportunities as investment vehicles. The web-based site described herein features search and matching capabilities that facilitate entrepreneurs and investors in meeting one another, communicating business and investment information, and commencing negotiations in a more efficient and cost effective manner.

The web-based site includes public and private portions. The public portion generally includes educational content, contact information, and a Quick Match portion, which is described in greater detail herein. The public portion additionally can be configured to include a business opportunity search capability with sample data, access to third party service providers, and the ability to register for the online service utilizing a computer network, such as the Internet. The private portion of the web-based site provides a detailed matching capability, a search for business opportunities, a Quick Assessment as described in greater detail herein, and access to a number of reports, which are also described in greater detail herein. Additionally, administrative and customer care functions can be available to customers.

The web-based site can be configured such that entrepreneurs and investors pay a fee to utilize services for a limited term subscription, for example, a six-month period, or indefinitely. Those skilled in the art can appreciate that such subscriptions can be paid for by credit card online, and processed by a specialized payment module or routine. Limited term trial subscriptions for entrepreneurs and investors can be utilized as a promotional vehicle to attract subscribers to the services offered by the web-based site described herein. Additionally, promotional codes can be provided to potential subscribers indicating the number of days available that the web-based site may be available for their use at no cost or reduced cost during the trial period.

Each registered user and authorized employee with access to the web-based site may themselves designate or be provided with a single log-in username and password. Users may select their own usernames and passwords. Identification of user types (e.g., entrepreneur, individual investor, or institutional investor) occurs during the registration process or can be assigned by customer care resources.

The term Quick Match as utilized herein refers to a routine, subroutine or software module that can be utilized by entrepreneurs to assist them in conceptually understanding how matching takes place and how many investors they may match with. Additionally, such a routine, subroutine and/or software module may encourage users to subscribe to the services offered by the web-based site described herein. The Quick Match module is available to anyone who enters the public portion of the web-based site. In a preferred embodiment of the present invention, an entrepreneur can enter approximately ten data items that describe their particular business or enterprise (e.g., type of industry and type of funding sought). Thus, this process can be generally referred to herein as simply Quick Match.

An icon or graphical button displayed within the web-based site, when selected by a user, initiates processing of the Quick Match module. Thus, after the entrepreneur enters the data items and runs Quick Match, the entrepreneur receives a messages indicating the number of investors seeking business opportunities that meet the business description provided by the Entrepreneur. Those skilled in the art can thus appreciate that the Quick Match module described above may be an interactive process, meaning that the entrepreneur can change business descriptions multiple times while online and thereafter view the effects of his or her changes on the number of investor matches generated. Data entries can be saved for entrepreneurs and utilized to pre-populate the Detailed Match process, if the entrepreneur becomes a member prior to exiting the current web-based site session. The “Detailed Match” process is described in greater detail herein.

The Detailed Match process, implemented for example as a routine, subroutine and/or software module, comprises a core function of the web-based site described herein. Only registered subscribers can run a Detailed Match and only after successfully logging into the system and entering some information about the user or entrepreneur's business. The Detailed Match process can be utilized by both entrepreneurs and investors; however the outputs for each type of subscriber are different.

After running a Detailed Match, entrepreneurs can view a list of investors with whom they have matched, while investors can view a list of potential business opportunities. Interested parties may contact one another utilizing e-mail features provided by the web-based site and also send additional descriptive information if they so choose. A Detailed Match report can be compiled and generated between an entrepreneur and an investor once each type of user has entered his or her appropriate business information. This process is thus generally referred to herein as simply “Detailed Match.”

Investors can also run an interactive search for business opportunities utilizing features provided by the web-based site. By defining a limited set of investment preferences, such as desired industries, investment stage and size, users can run an interactive search and thereby obtain a list of potential business opportunities. This process can be referred to herein as simply Business Opportunity Search. The outputs and follow-up process are similar to those obtained when running a Detailed Match, as described herein. Business Opportunity Search results may or may not be saved.

Quick Match is generally “located” in the public portion of the web-based site and may be generally available to everyone; however, it is based on an Entrepreneur's perspective. Quick Match output provides the number of potential investors matching the entrepreneur/user based on a limited set of data items. The Detailed Match, on the other hand, can be based on algorithms that integrate and mine substantial usage, deal information and external data to identify investors and entrepreneurs who otherwise may not come into contact with one another.

The Business Opportunity Search module can be implemented as a traditional SQL (Structured Query Language) search criteria selection and database query function, and may be generally performed by investors only. Business Opportunity Search may be completely interactive, while the Detailed Match can be based on investor pre-defined information stored in a database.

Quick Assessment can be implemented as a routine, subroutine and/or module that run by entrepreneurs to provide a summary of their company's relative financial condition, and identify potential support from third-party service provides, such as employee recruiting services. “Quick Assessment” can be configured such that access by entrepreneurs occurs only after the entrepreneur logs into the system.

Users also may have access to a customer care resource for off-line support. The customer care resource may include an individual who answers questions via a toll free telephone number and also responds to e-mail queries. Such a customer care resource can also walk a client through the process or address issues by viewing the same screens accessed by the client. Both the customer care resource and the user can thus walk through the same screens together at the same time. The customer care resource preferably reviews all free-form data input by entrepreneurs and investors before it is available to be viewed by other community members.

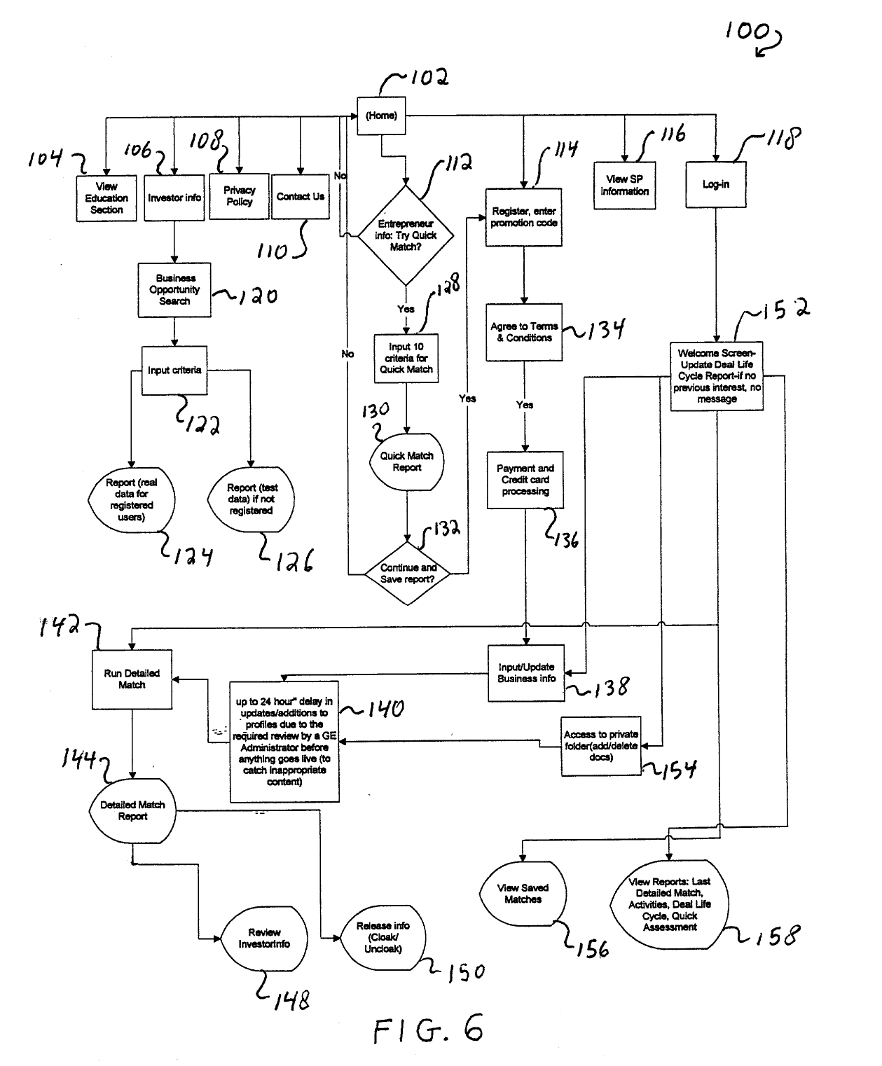

FIG. 6 depicts a flow chart of operations 100 illustrative of a method for interactively enabling venture financing for entrepreneurs, from an entrepreneur-perspective, in accordance with a preferred embodiment of the present invention. As indicated at block 102, a member (after login) initially is faced with a “homepage” displayed within a web browser in a display screen of a video display terminal, such as video display terminal 24 of FIG. 1. The homepage generally is the initial point of entry for a member after login. The term homepage, as utilized in the computer arts, generally refers to a document that serves as a starting point in a hypertext configuration. The homepage is typically linked to other pages that together make up a web-based site.

From the homepage, as depicted at block 102, the user may link to other sections of the web-based site. A top-level navigation bar is generally available on all pages or screens. As illustrated at block 104, the user can link to a page containing an education section generally providing information about the financing process available via the web-based site. The education information available in the educational section is generally displayed in static format for the user, rather than in an interactive format.

The user can also link to an investor information section utilizing a graphically displayed “investor” button, as depicted at block 106. By selecting the investor button, the user is linked to a page providing a Business Opportunity Search section, as illustrated at block 120.

The user may also view privacy policy information, as described at block 108. The user is linked from the homepage to a page containing privacy policy information utilizing a graphically displayed icon or button associated with this particular page. Privacy policy information is displayed for the user in a static format. Additionally, the user may link from the homepage or from any page via top level navigation buttons to a page providing contact information, such as, for example, a toll free telephone number that the user can call to talk to a customer care resource representative. Additionally, this page may also contain an e-mail feature that permits the user to e-mail questions and comments.

As illustrated at block 114, the user can also link from the homepage utilizing top level navigation buttons to a page that provides input buttons that permit the user to register online for the venture matching service. Such services are not offered to users who fail to register.

As depicted at block 116, a user may also click a top-level navigation button to view service provider (SP) information. Such service provider information describes the type of services offered by third-party service providers, along with one or more pages of promotional information and the SP logo. Such additional pages may be accessed utilizing links displayed together with service provider information. Information files in the form of pdf files, well-known in the art, may also be displayed along with the promotional information. The user may login to the web-based site, as indicated at block 118, once registration is complete.

As depicted at decision block 112, a user is generally provided with the option of linking from the homepage to a page that initiates the Quick Match process or feature described earlier. If the user does not access the Quick Match feature, the user simply continues viewing the homepage, as indicated at block 102. If the user does access the Quick Match feature, then as illustrated at block 128, the user may be required to input particular criteria to initiate the Quick Match process. The purpose of Quick Match is to show customers and potential customers how the matching process works. All users may access the Quick Match features. Quick Match, however, may preferably be implemented as a feature geared toward entrepreneurs. Thus, the information generated by Quick Match is generally of more use to entrepreneur users, rather than investors or other users.

Quick Match may be implemented as a free service, without the necessity of utilizing graphically displayed “login” buttons. The user simply accesses a button labeled, for example, “entrepreneur” from a navigation bar. Graphical buttons and icons associated with particular hyperlinks to particular web pages (e.g., Quick Match) can be displayed in the top-level navigation bar. The user inputs answers to questions provided by the Quick Match feature. These answers are stored as limited business information on a server associated with the web-based site.

The user selects a graphically displayed Quick Match button to initiate processing of Quick Match operational functions. Thereafter, the number of potential investors (i.e., based on real investor data) that match appear on the display screen. Details are not provided, but a textual message may be displayed, such as, “We have identified 15 potential investors that have an investment profile that matched the business opportunities you have outlined.” The number of potential investors may be provided for the user via a Quick Match report, as illustrated at block 130.

The user may be provided with an option to save the Quick Match search results (for the current session only), as indicated thereafter at decision block 132. In order to save the report, the user must input identifying information, such as first name, last name, e-mail address, phone number, and so forth. This information may be saved and can thereafter populate the entrepreneur/user registration screen if they chose to register during the initial user session, as indicated at block 114. If the user chooses to save the report and continue, the user may be guided through the registration process, as indicated at block 114. If the user chooses not to save the report and continue, Quick Match terminates and the user may be returned to the homepage, as depicted at block 102.

The registration process begins, as indicated at block 114, and continues, as illustrated at block 134, wherein the customer inputs registration information and electronically agrees to particular terms and conditions related to the use of the web-based site. The user/customer (entrepreneur) must pick his or her own unique user identification code and password. If the user chooses an identification code and password that has already been utilized by another user, the user may be prompted to input an alternative identification code and password. The user may be generally required to input his or her identification code and password twice to confirm entry during initial registration.

The user can also be required, as described at block 114, to enter an optional promotional code. Payment and credit card processing may thereafter occur, as depicted at block 136. A user, for example, may be required to pay a fee of, for example, $300 for six months of service by entering appropriate credit card and address/contact information online. Those skilled in the art can appreciate that the subscription rate and period can vary and may change depending on the needs and circumstances of the site operators/administrators.

Customer verification may be provided on-screen. If the information provided by the user is incorrect, the user may be provided with a message indicating, for example, that “You have been denied access, please enter a new credit card or call toll free for assistance.” Such information can be corrected or updated, as indicated at block 138. If the user is approved, a message, such as “You have been approved,” can be displayed for the user. An additional message can be generated indicating that up to a 24 hour delay in updates/additions to the user's profile can occur, due to required review by an appropriate site administrator or site customer care resource. Such a requirement may be necessary to “catch” mistakes or inappropriate material before any user-provided content may be accessible “live” via the web-based site, as depicted at block 140.

The Business Opportunities Search module can be initially implemented, as indicated at block 120. The Business Opportunities Search feature can be utilized to identify entrepreneurs who meet limited criteria defined by investors. The Business Opportunities Search feature may be processed according to user defined selection criteria, as indicated at block 122. Such a search can be performed multiple times, depending on the needs of the user.

If the user is a registered investor user, then as described at block 124, the generated report includes “real” data. If the user is not a registered user, then the report generated includes sample data. The results can be displayed simply as a sentence or two highlighting business ideas/sales pitches, industry, stage, state, corporate, current estimated revenue and the amount of money that the entrepreneur is attempting to raise.

The login feature of the web-based site described herein is generally initiated, as illustrated at block 118. The login feature permits a user to update his or her user profile and manage his or her associated web-based site account. If the user forgets his or her password, the user may contact the web-based site administrator by sending an e-mail message requesting appropriate password information, or the user may call a toll free telephone number. A company customer care resource representative may ask the user for his or her e-mail address, and/or additionally ask the user to send an e-mail requesting the password.

Information provided by the user can be compared to user information already maintained in a database, and thereafter, verification information can be sent back to the user, including the user's identification code and password. If the login information provided by the user is invalid, a message can be displayed for the user, indicating, for example, “Invalid user identification or password.” If the login information provided by the user has expired, the user can be notified and returned to a user registration page, as indicated at block 114, to register again.

If login is successful, an entrepreneur homepage or entrepreneur “Welcome Screen” can be displayed for the user, as described at block 152. The entrepreneur homepage may be displayed according to a particular user group. If the user, for example, has registered as an entrepreneur, then the displayed page may be geared toward “entrepreneurs.” If, however, the user is an investor, the homepage displayed is generally an investor based welcome screen.

The homepage may be available only after login and provides a personalized message for the user and a list of options. The user can be prompted to update a “Deal Life Cycle Report” associated with each investor each time that the user (entrepreneur) accesses the system, as illustrated at block 158. A “Deal Life Cycle Report” provides the site administrator with the progress of each ongoing investor/entrepreneur deal. The administrator can view the “Deal Life Cycle Report” from both the investor and entrepreneur perspectives.

Initial contact may be system generated when either an entrepreneur or investor contacts the other party via the web-based site. The entrepreneur may be prompted weekly to enter information describing the deal progress. The entrepreneur may be responsible for entering data related to NDA (Nondisclosure Agreement), deal size, target closing date, and deal funding. The investor may be prompted weekly to enter the deal progress, including data related to due diligence, term sheet, investor approval, post-approval due diligence, and deal funding. The site administrator generally has the ability to update any field in the “Deal Life Cycle Report.”

The user can also view other reports, as depicted at block 158, including a “Detailed Match Report,” “Activities Report,” and a “Quick Assessment” report. Quick Assessment was described earlier herein, along with the Detailed Match report. Other reports that a user (entrepreneur) may access from the Welcome Screen include a report displaying a list of investors interested in his or her idea. The user can also receive weekly, a notice by e-mail indicating that “there has been some activity in your account,” along with a hyperlink in the body of the e-mail message to a page providing additional details.

As illustrated at block 156, the user can view the results of previously saved investor matches. The user may also be provided access to private folders or a private holding area, as depicted at block 154, wherein documents may be added or deleted. Optionally, the user may need to wait more than 24 hours for approval to additions or deletions, as depicted thereafter at block 140. Note that no time commitments are likely to be provided to the customer. As described at block 138, the user can also input/update business information utilized in association with the Detailed Match, Quick Assessment, and Business Opportunity Search features described herein. Again, the user may be required to wait more than 24 hours before updated/deleted business information may be available online, as illustrated thereafter at block 140.

The Detailed Match report may be available for subscribers only and may be processed, as indicated at block 142, following completion of the operation described at block 140 or the operation depicted at block 152. The user may be permitted, as illustrated at block 144, to view a Detailed Match report after the Detailed Match module is processed, as indicated previously at block 142. The user (entrepreneur) can view the Detailed Match report with limited investor details. Output of the Detailed Match module can be dynamically generated upon user request utilizing on-screen selection buttons.

The entrepreneur/user can view a report which may include information related to an investor or list of investors. Such information includes investor type, portfolio size and associated financial information, hi-lighted deals, industry information, pitch template, description of the approval process, investment banker relationships, and so forth, as a result of the Detailed Match. The customer care resource representative reviews the data for appropriateness. Prior to completion of this review, the entrepreneur may not send e-mail or other information to the investors. After approval by the customer care resource representative, the entrepreneur can view a report, which includes investor type, investor names, a list of investors, pitch template, partial information from the Detailed Match output, and so forth.

At this point, the entrepreneur may select an investor and send an e-mail with standard text that cannot be edited by the entrepreneur. The entrepreneur may be asked whether or not he or she desires to allow the investor to view his or her executive summary as cloaked or uncloaked information. Cloaked information is generally composed of only particular information that one party wishes another party to view. The other party may view the uncloaked information but may not see the cloaked or hidden information. The entrepreneur can also attach files, such as business plans, to the e-mail message sent to the investors. The entrepreneur may also send e-mail to the identified investor, which includes a hyperlink to the site homepage.

After the investor sends an e-mail indicating interest and agrees to release all contact information (uncloaked information), the entrepreneur may view all investor profile information (e.g., contact name, phone number, and so forth). When the Detailed Match report is generated, the user may review investor information, as depicted at block 148. Information may be released to the investors, as uncloaked or cloaked information, as described at block 150.

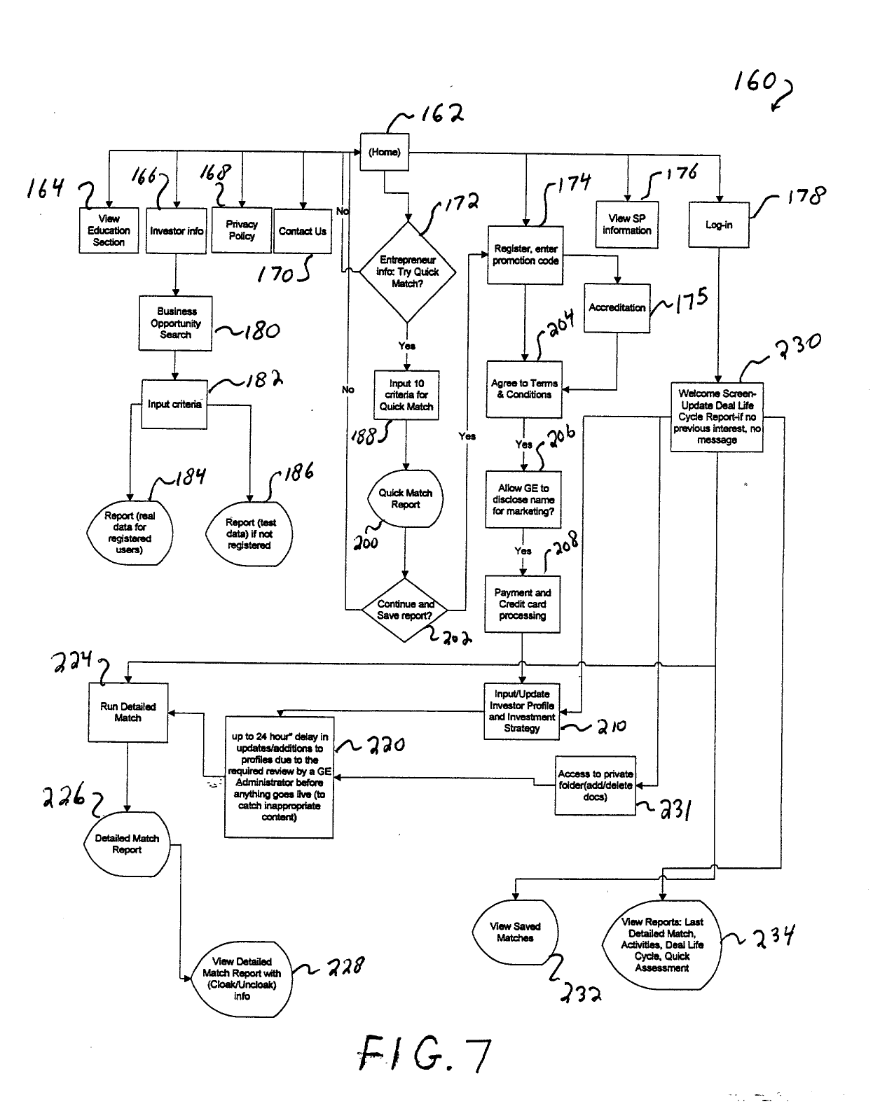

FIG. 7 illustrates a flow chart of operations 160 illustrative of a method for interactively enabling venture financing for entrepreneurs, from an investor-perspective, in accordance with a preferred embodiment of the present invention. As indicated at block 162, a user initially is faced with a “homepage” displayed within a web browser in a display screen of a video display terminal, such as video display terminal 24 of FIG. 1. The homepage is generally the initial point of entry to the web-based site.

From the homepage, as depicted at block 162, the user may link to other sections of the web-based site. A navigation bar with graphically displayed icons may be found in the homepage and is generally available in all pages or screens. As illustrated at block 164, the user can link to a page containing education information that describes how the financing process available via the web-based site operates. The education information may be displayed in a static format for the user, rather than an interactive format.

The user can also link to an investor section utilizing a graphically displayed “investor” button, as depicted at block 166. By selecting the investor button, the user may be linked to a page providing a Business Opportunity Search section, as illustrated at block 180.

The user may also view privacy policy information, as described at block 168, by linking to a page containing privacy policy information, utilizing a graphically displayed icon or button associated with that particular page. Privacy policy information may be displayed for the user in a static format. Additionally, the user may link from the homepage or from any page via top level navigation buttons to a page providing contact information, such as, for example, a toll free number that the user can call to talk to a web-based site representative. Additionally, this page may also contain an e-mail feature wherein a user may e-mail the web-based site operator with questions and comments.

As illustrated at block 174, the user can also link via top level navigation buttons to a page that provides input buttons that permit the a user to register online and subscribe to other services offered by the web-based site. Such services may not be offered to users who fail to register for the services provided by the web-based site.

As depicted at block 176, a user may also click a top-level navigation button from the homepage or other pages of the web-based site to view service provider (SP) information. Such service provider information contains information about the type of services offered by third-party service provides, along with one or more pages of promotional information. Such pages can be accessed utilizing hyperlinks displayed together with the service provider information. Banner adds can also be displayed along with the promotional information. The user may login to the web-based site, as indicated at block 178, once registration is complete.

As depicted at decision block 172, the user may link from the homepage via graphically displayed hyperlinks to a page that initiates the Quick Match process or feature described earlier. If the user does not access the Quick Match feature, the user simply continues viewing the homepage, as indicated at block 162. If the user does access the Quick Match feature, then as illustrated at block 188, the user may be required to input particular criteria to initiate the Quick Match process. The purpose of Quick Match is to show customers and potential customers how the matching process works. All users may access the Quick Match features. Quick Match, however, is a feature geared toward entrepreneurs. Thus, the information generated by Quick Match is generally of more use to entrepreneur users, rather than investors or other users.

Quick Match can be implemented as a free service, without the necessity of utilizing “login” buttons. The user simply accesses a button labeled, for example, “entrepreneur” from a top-level navigation bar wherein graphical buttons and icons associated with particular hyperlinks to particular web pages (e.g., Quick Match) are displayed. The user inputs answers to questions provided by the Quick Match feature. These answers are stored as limited business information on a server associated with the web-based site.

The user selects a graphically displayed Quick Match button to initiate processing of Quick Match operational functions. Thereafter, the number of potential investors (i.e. “real” data) that they matched appears on the display screen. Details are not provided, simply a textual message, such as, “We have identified 15 potential investors that have an investment profile that matched the business opportunities you have outlined.” The number of potential investors is provided for the user via a Quick Match report, as illustrated at block 200. The user may be provided with an option to save the Quick Match search results (for the current session only), as indicated thereafter at decision block 202. Preferably, however, only those users who register as entrepreneurs, rather than investors, will be allowed to access this features.

To save the report, the entrepreneur/user inputs identifying information, such as first name, last name, e-mail address, phone number, and so forth. This information can thereafter populate the entrepreneur/user registration screen if the user chose to register during the initial user session, as indicated at block 174. If the user chooses to save the report and continue, the user is guided through the registration process, as indicated beginning at block 174. If the user chooses not to save the report and continue, Quick Match terminates and the user is returned to the homepage, as depicted at block 162.

The registration process begins, as indicated at block 174, and continues, as illustrated at block 204, wherein the customer inputs registration information and agrees to the terms and conditions provided by the operators of the web-based site. The user/customer (entrepreneur) must pick his or her own unique user identification code and password. If the user chooses an identification code and password that has already been utilized by another user, the user is prompted to input an alternative identification code and password. The user is generally required to input his or her identification code and password twice to confirm entry during initial registration.

The user can also be required, as described at block 174, to enter an optional promotional code. Following processing of the operation depicted at block 204, wherein the user must agree to particular terms and conditions in order to access the web-based site, the user may be prompted, as depicted at block 206, to agree to permit the site administrator to disclose the user's name for marketing purposes. If so, then as illustrated at block 208, appropriate payment and credit card modules are processed. Following processing of appropriate payment and credit card modules, the user (investor) may input new information to create an investor profile or update an existing investor profile, along with investment strategy data, as indicated at block 210.

Customer verification may be provided on-screen following processing of payment and credit card information. If the payment and credit card information provided by the user (investor) is incorrect, the user may be provided with a message indicating, for example, that “You have been denied access, please enter a new credit card or call toll free for assistance.” Such information can be corrected or updated, as indicated at block 210 and may be incorporated into the investor profile.

If the user is approved, a message, such as “You have been approved” can be displayed for the user. An additional message may be generated indicating that up to a 24 hour delay in updates/additions to the user's profile can occur due to required review by an appropriate site administrator or site customer care resource. Such a requirement may be necessary to “catch” mistakes or inappropriate material before any user-provided content may be accessible “live” via the web-based site, as depicted at block 220.

The Business Opportunity Search module can be initially implemented, as indicated at block 180. The Business Opportunity Search feature provided by the web-based site may be utilized to identify entrepreneurs meeting limited criteria defined by investors. The Business Opportunity Search feature may be processed according to user defined selection criteria, as indicated at block 122. Such a search can be performed multiple times, depending on the needs of the user. Results are displayed in two possible formats, as described at blocks 184 and 186.

If the user is a registered user, then as described at block 184, the generated report includes “real” data. If the user is not a registered user, then the report generated may simply include sample data for example purposes only. The results can be displayed simply as a sentence or two highlighting business ideas/sales pitches, industry, stage, state, corporate, form current year estimated revenue and the amount of money that the company in question is attempting to raise.

The login feature of the web-based site described herein is generally initiated, as illustrated at block 178. The login feature essentially permits a user (investor) to update his or her investor profile and manage his or her associated web-based site account. If the user forgets his or her password, the user may contact the web-based site administrator by sending an e-mail message requesting appropriate password information, or the user may call a 1-800 telephone number.

A customer care resource representative may ask the user for his or her e-mail address, and/or additionally ask the user to send an e-mail requesting the password. Information provided by the user is compared to user information already maintained in a database and verification information can then be sent back to the user, including the user's identification code and password. If the login information provided by the user is invalid, a message can be displayed for the user, indicating, for example, “Invalid user identification or password.”

If the login information provided by the user has expired, the user can be notified and returned to a user registration page, as indicated at block 174, to register again. If login is successful, an “Investor Home” or investor “Welcome Screen” can be displayed for the user, as described at block 230. If the user has registered as an investor, then the displayed Welcome Screen that he or she views will comprise a screen geared toward investors rather than entrepreneurs.

The Welcome Screen or homepage is available only after login has occurred, and provides a personalized message for the user, along with a list of options. The user can be prompted to update a “Deal Life Cycle Report” associated with each investor each time that the user (entrepreneur) accesses the system, as illustrated at block 234. A “Deal Life Cycle Report” provides the web site administrator with a progress of each ongoing investor/entrepreneur deal.

The site administrator can view the “Deal Life Cycle Report” from both the investor and entrepreneur perspectives. During the first thirty days after an investor has registered, an investor may be matched with “Business Opportunities” (i.e., entrepreneurs) that have registered with the web-based site after the investor has done the same.

Initial contact may be system generated when either an entrepreneur or investor initiates contact with the other party via the web-based site. The investor may be contacted weekly to enter information describing the deal progress. The web-based site administrator can be provided with the ability to update any field in the “Deal Life Cycle Report.”

The user can also view other reports, as depicted at block 234, including a “Detailed Match Report,” “Activities Report,” and a “Quick Assessment” report. Quick Assessment was described earlier herein, along with the Detailed Match report. Other reports that a user (investor) may access from the Welcome Screen include a report displaying a list of investors interested in his or her idea. The user can also receive weekly, a notice by e-mail indicating that “there has been some activity in your account,” along with a hyperlink in the body of the e-mail message to a page providing additional details.

As illustrated at block 232, the user can view the results of previously saved investor matches. The user may also access private folders or a private holding area, as depicted at block 231, following processing of the operation described at block 230. Documents may be added or deleted to the private folders or private holding area. Optionally, the user may need to wait 24 hours for approval to additions or deletions, as depicted thereafter at block 220.

As described at block 210, the user can also input/update business information utilized in association with the Detailed Match, Quick Assessment, and Business Opportunity Search features described herein. Again, the user may be required to wait 24 hours before updated/deleted business information may be available online, as illustrated thereafter at block 220.

The Detailed Match report is generally available for subscribers only and may be processed, as indicated at block 224, following completion of the operation described at block 220 or the operation depicted at block 230. The user may be permitted, as illustrated at block 226, to view a Detailed Match report after the Detailed Match module may be processed, as indicated previously at block 224. The user (investor) can view the output of the Detailed Match module in the form of a dynamically on-screen report, in response to user input or selection of on-screen graphically displayed icons or buttons.

The Detailed Match report generated by a user (investor) may be dynamically generated upon request, reflecting a current profile. Some entrepreneur information in the report may be cloaked. If the investor is interested in contacting the entrepreneur, the investor simply “clicks” a graphically displayed icon or button with a pointing device, such as a mouse, to send generic e-mail to the entrepreneur. The investor may not view business opportunities (i.e., entrepreneurs) that were entered before the investor registered, unless the investor has been registered for more than thirty days. The entrepreneur may then respond to the investor with an e-mail message with links to a web site containing additional entrepreneur information. Information included in the Detailed Match report viewed by the investor may be cloaked, depending on how the information was originally designated by the entrepreneur (i.e., cloaked or uncloaked).

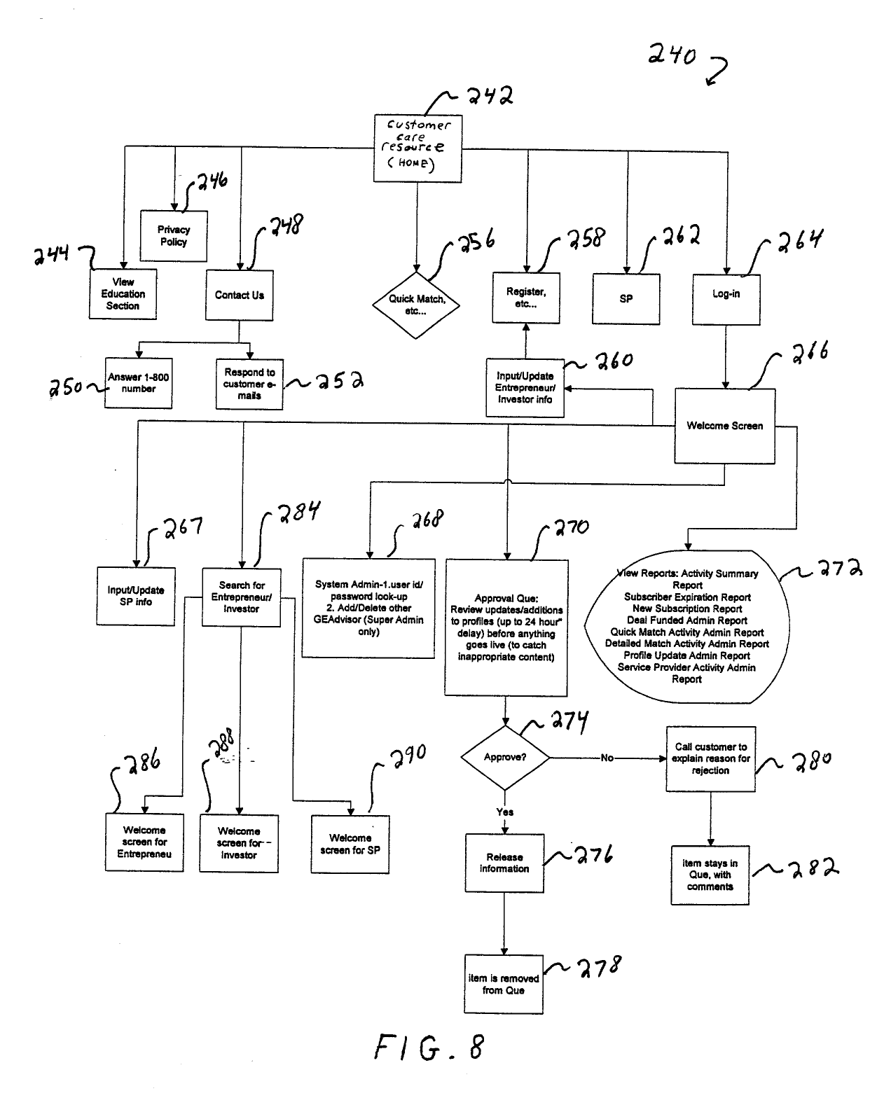

FIG. 8 depicts a flow chart of operations 240 illustrative of a method for interactively enabling a customer care resource module, in accordance with a preferred embodiment of the present invention. The method illustrated in FIG. 8 enables customer care resources to assist entrepreneurs and investors enter profile information, while managing business, financial, database, and other interactive online activities through the web-based site. The customer care resource is necessary to review for appropriateness and/or approve investor- and entrepreneur-provided information. The customer care reviews all investor- and entrepreneur-provided information before a user can see uncloaked results of a Detailed Match and Business Opportunities Search.

Approval may be required by the customer care resource for any inputs/updates made by entrepreneur and investor users. The customer care resource also monitors via an Approval Queue Screen, documents posted to the entrepreneur's private folders and changes made thereof by the user. The customer care resource generally should review user profiles, and approve uploaded documents. If such information is reviewed for appropriateness and approved, the information is posted to the web site. Once approved, an item may be removed from the Approval Queue. If rejected, the customer care resource may contact the user.

As indicated at block 242, the customer care resource begins managing activities via top level navigation buttons or icons displayed within the web-based site homepage. Thus, as indicated at block 244, the customer care resource may access an education section. The operation depicted at block 244 is analogous to the operations described at block 104 of FIG. 6 and block 164 of FIG.7. The customer care resource may also access privacy policy information, as illustrated at block 246. The operation illustrated at block 246 is analogous to the operations described at block 108 of FIG. 6 and block 168 of FIG. 7. The customer care resource also responds to user contact, as indicated at block 248.

A customer care resource representative may answer user questions via a toll free telephone number, as indicated at block 250, or responds to customer/user e-mail messages, as illustrated at block 252. The operation described at block 256 is analogous to the operations described at blocks 112, 128, 130, and 132 of FIG. 6, and blocks 172, 188, 200, and 202 of FIG. 7. For illustration purposes only, the customer care resource is referred to in FIG. 8 as a General Electric (GE) customer care resource or advisor. In addition, the customer care resource has access to third-party service provider information, as illustrated at block 262. The operation described at block 262 is generally analogous to the operation illustrated at block 116 of FIG. 6 and block 176 of FIG. 7. Note that as utilized herein, the term customer care resource may be substituted with the word advisor.

Additionally, the customer care resource can follow a login process, as depicted at block 264. The operation depicted at block 264 is analogous to the operation depicted at block 118 of FIG. 6 and block 178 of FIG. 7. After login, the customer care resource can view a customer care resource homepage, as illustrated at block 266. Such a homepage provides a customer care resource with a variety of administration and account management options. A customer care resource representative can view particular reports, as illustrated at block 272, such as an activity summary report, a subscriber expiration report, new subscription reports, deal funded administration report, Quick Match activity administration report, Detailed Match activity administration report, Profile Update administration report, and a service provider activity administration report.

The customer care resource can also view an Approval Queue via the homepage to review updates/additions to user-entered information before any information is posted “live” online via the web-based site, as illustrated at block 270. If the customer care resource approves information contained in the Approval Queue, then as indicated at block 276, the new information is released and posted to the web-based site and thereafter the related item is removed from the Approval Queue, as depicted at block 278. If the information is rejected by the customer care resource representative, then as indicated at block 280, a the customer may be contacted with an explanation, and the item removed from the Approval Queue with appropriate comments, as illustrated at block 282.

System administration is generally managed through the use of passwords and user identification codes, as illustrated at block 268. If a user forgets his or her password, he or she must contact a customer care resource representative via telephone or an e-mail message. If the customer care resource representative determines that such user-provided information is valid, the customer care resource representative can send an e-mail message back to the customer with appropriate password and identification information. A customer care resource supervisor may add, update, or delete other customer care resources. The customer care resource generally can update information for the entrepreneur and investor users and keep track of who had been updating information (i.e., entrepreneurs/investors). The customer care resource may also access private folders of entrepreneurs and investors.

The customer care resource may also search for entrepreneurs and investors, as indicated at block 284, and also access specific user group homepages, such as an entrepreneur Welcome Screen, as illustrated at block 286; a Welcome Screen for investors, as indicated at block 288; and a Welcome Screen for third-party service providers, as illustrated at block 290. The customer care resource may also input third-party service provider information, as illustrated at block 267 and make additions, updates, or deletions to such information. The customer care resource can also utilize the customer care resource homepage to input/update entrepreneur and investor information, as illustrated at block 260.

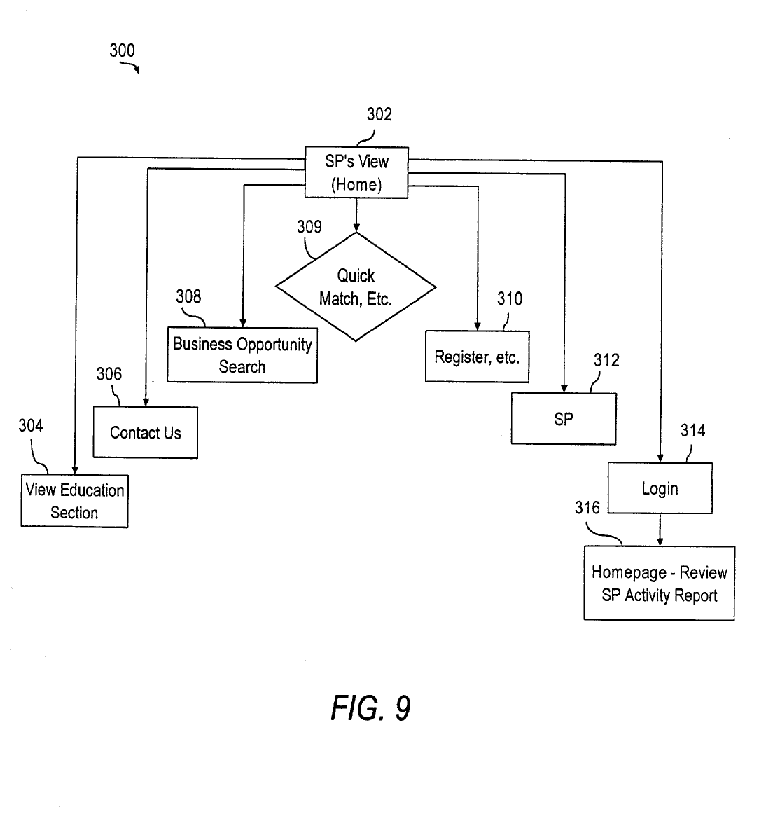

FIG. 9 illustrates a flow chart of operations 300 illustrative of operational steps for implementing third-party service provider access to a web-based site, in accordance with a preferred embodiment of the present invention. As illustrated at block 302, a third-party service provider can view the web-based site homepage and thereby access top level navigation buttons and icons, including icons or buttons, which when selected, provide access to an educational section, as illustrated at block 304, a contact section as indicated at block 308, a Business Opportunity Search section as illustrated at block 308, a Quick Match section as indicated at block 309, a registration section as depicted at block 310, a third-party service provider section as described at block 312, and a login section as illustrated at block 314.

Those skilled in the art can appreciate that the operations depicted herein are analogous to appropriate operations described relative to preceding figures and drawings (e.g., FIG. 6, FIG. 7, FIG. 8). Following login, the third-party service provider may view a Welcome Screen wherein third-party service provider activity reports are available for review.

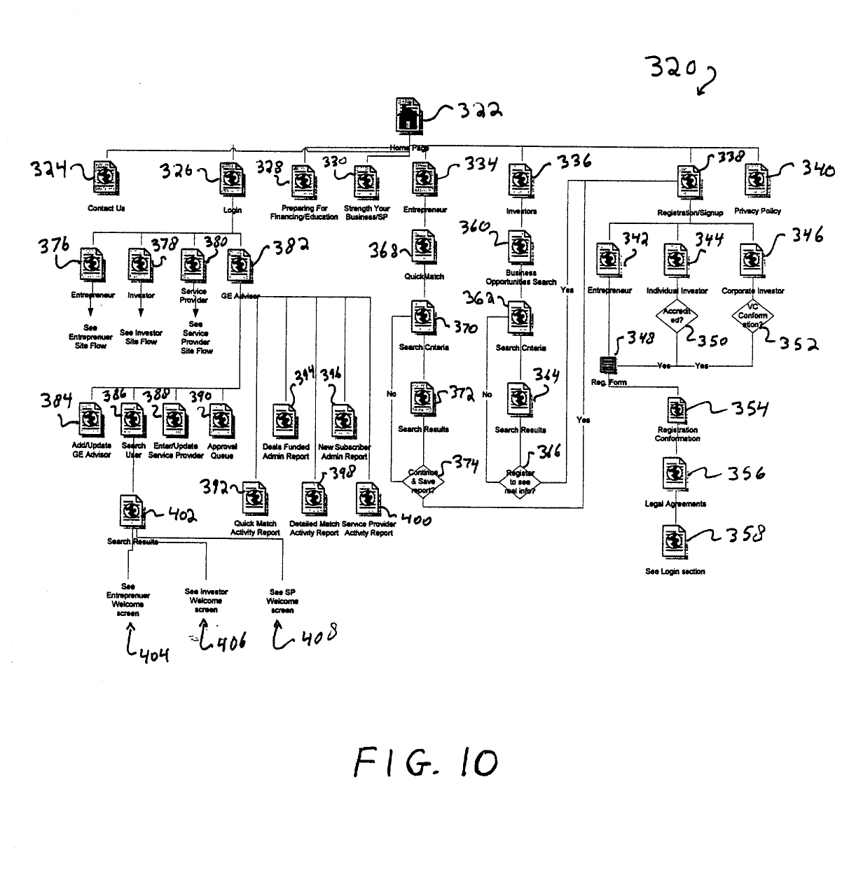

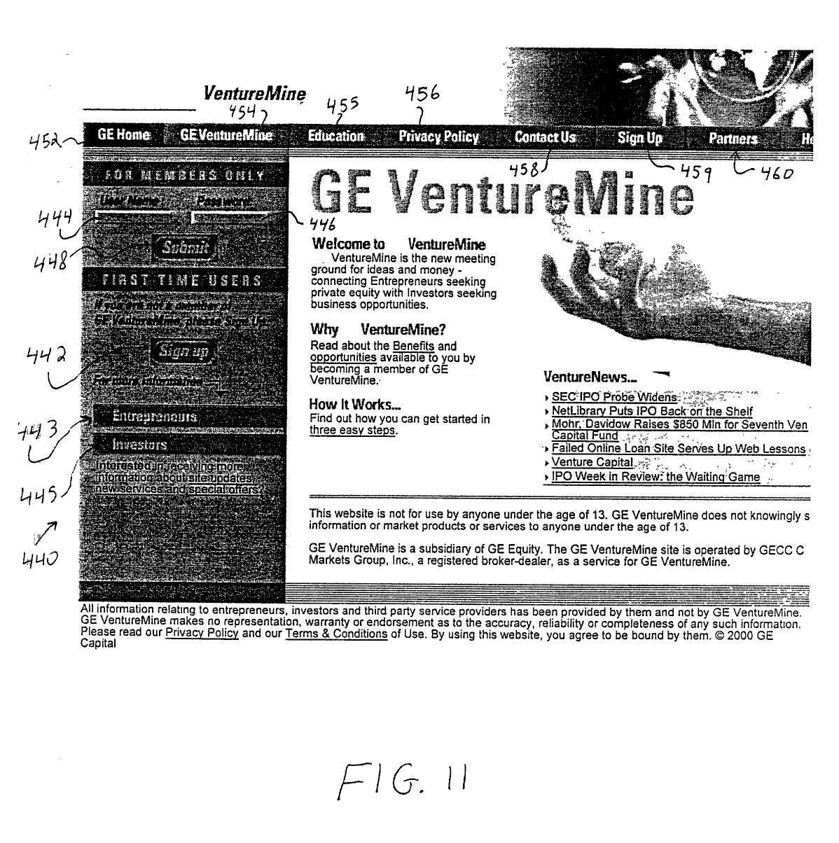

FIG. 10 depicts a web-based site diagram 320 illustrative of operations for interactively enabling venture financing for entrepreneurs, in accordance with a preferred embodiment of the present invention. As illustrated at block 322, the web-based site includes a homepage, wherein a variety of options are available for selection by a user. As depicted at block 324, a user may contact the site operators or administrators.

As indicated at block 326, a user may log into the web-based site as a particular user. Users are categorized as entrepreneurs, as illustrated at block 376, investors, as described at block 378, third-party service providers as illustrated at block 380, or customer care resources, as depicted at block 382. If the user is an entrepreneur, then the operational steps depicted in FIG. 6 can be implemented. If the user is an entrepreneur, then the operational steps illustrated in FIG. 7 are implemented. If the user is a third-party service provider, the operational steps depicted in FIG. 9 can be implemented.

If the user is a customer care resource, then as illustrated at block 384, the customer care resource may add/update another customer care resource. The customer care resource may search for a particular user, as illustrated at block 386. The customer care resource may also enter/update information relative to a particular third-party service provider, as illustrated at block 388. Additionally, the customer care resource may access, update or alter the Approval Queue, as illustrated at block 390. If the customer care resource searches for a particular user, as described at block 386, search results are displayed for the customer care resource, as illustrated at block 402. The customer care resource is then referred to the appropriate “Welcome Screen” as indicated at blocks 404, 406, and 408 (i.e., entrepreneur, investor, third-party service provider).

The customer care resource may also view a Quick Match activity report, as illustrated at block 392; a Deals Funded administration report, as described at block 394; a Detailed Match activity report, as depicted at block 398; a New Subscriber administration report, as indicated at block 396; or a third-party service provider activity report, as depicted at block 400.

A user may also access information regarding financing/education preparation, as illustrated at block 328; and “strengthening your business,” as indicated at block 330. Entrepreneurs access an “entrepreneur” button or icon displayed at the homepage, as illustrated at block 334. The entrepreneur may then run a Quick Match module, as indicated at block 368 with particular Quick Match criteria, as illustrated at block 362, and thereafter obtain search results, as depicted at block 364. The entrepreneur may then save generated results via a report and continue with the financing process, as illustrated at block 374. The user can thereafter register with the web-based site, as illustrated at block 338.

The investor/user may access an “investor” button or icon displayed on the homepage, as illustrated at block 336. The investor may search for business opportunities (i.e., entrepreneurs), as illustrated at block 360, with appropriate search criteria, as illustrated at block 362. Search results can be thereafter generated, as described at block 364 and the investor can register to view “real” data, as indicated at block 366. The investor may perform another search or register, as illustrated at block 338. The user may also access privacy policy information from the homepage, as illustrated at block 340.

If the user chooses to register, as illustrated at block 338, the user may be identified as an entrepreneur as depicted at block 342, an individual investor as illustrated at block 344, or a corporate investor, as described at block 346. If the user is an entrepreneur, the user simply fills out an online registration form, as depicted at block 348 and thereafter registration confirmation may be provided, as described at block 354. The user must sign particular online legal agreements as indicated at block 356 and thereafter proceed to a login section of the web-based site, as described at block 358.

If the user is an individual user, as illustrated at block 344, a determination must be made, as indicated at block 350, whether or not the investor is an accredited investor. If so, the investor may then fill out the registration form as indicated at block 348. If the user is a corporate investor, as described at block 346, a determination must be made as to whether the corporate investor is a venture capital (VC) confirmed investor. If so, the corporate investor may then proceed to fill out the registration form.

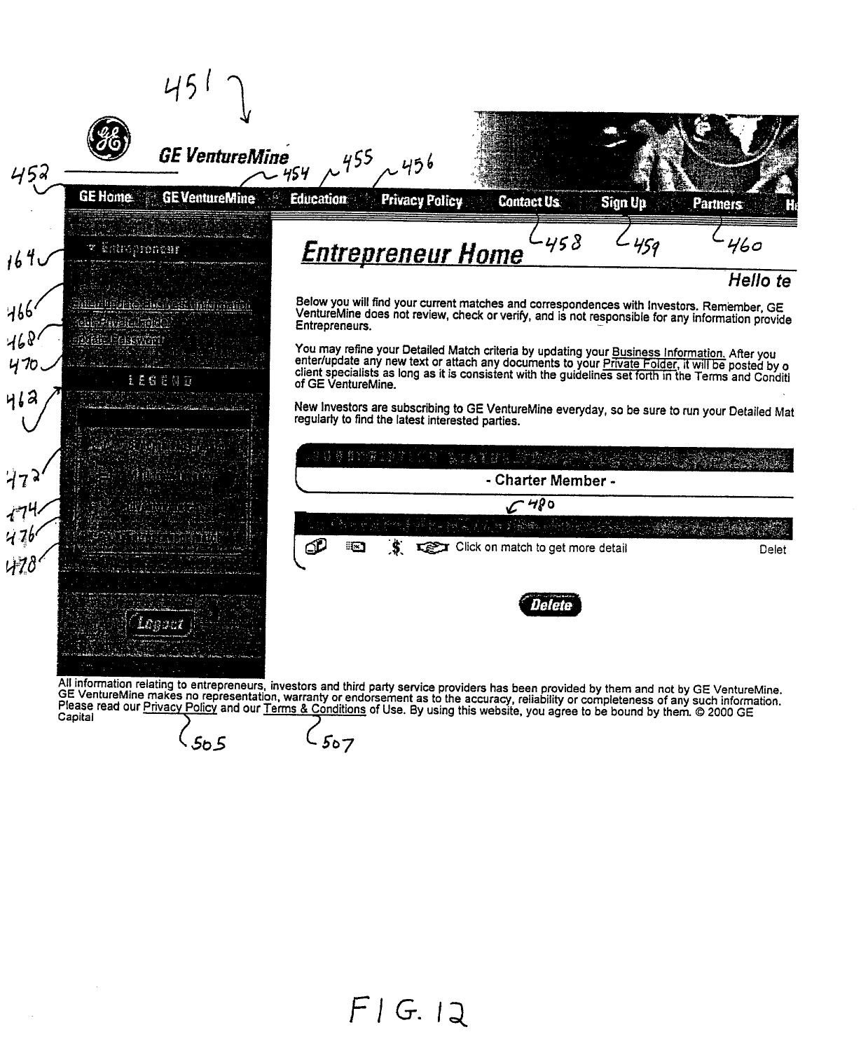

FIG. 11 illustrates a pictorial diagram 440 illustrating a web-based site homepage, in accordance with a preferred embodiment of the present invention. Those skilled in the art can appreciate that pictorial diagram 440 represents information that can be displayed within a web browser window to form portions of a web page and thereby, sections of a web-based site. Pictorial diagram 440 thus illustrates a home page of a web-based site that can be utilized to implement the method and system of the present of the invention.

Various graphically displayed icons are generally displayed within the homepage, which allow a user to link to other pages and thus, other sections of the web-based site. For example, by clicking icon 452 labeled “GE Home,” a user can view the homepage of the parent company, which in this illustration is “General Electric”.

By clicking icon 454, a user may access the features and controls that initiate the actual process of providing investor or entrepreneur information and run various modules, such as the Quick Match module described earlier. By clicking icon 455, a user can access educational material, thereby initiating a process, such as the operational step described at block 104 of FIG. 6 herein. By clicking icon 456, a user may access a web page containing privacy policy information, thereby initiating a process, such as the operational step described at block 108 of FIG. 6 herein.

Clicking icon 458 permits a user to link to a page containing contact information, thereby initiating a process, such as the operational step described at block 110 of FIG. 6. To register to gain access to private sections of the web-based site, a user can “click” icon 459, labeled “sign up,” and thereby register according to particular operational steps, such as those depicted in blocks 114, 134, and 136 of FIG. 6. Clicking icons 442 can also initiate the same registration process. When a user “clicks” icon 460, the user can view third party service provider information.

If the user is an investor, the user clicks icon 445 to link to a page that initiates processing of investor-provided data or information to compile investor profiles. If the user is an entrepreneur, the user clicks icon 443 to link to a page that initiates processing of entrepreneur-provided data to compile entrepreneur profiles and operational steps implementing the method and system described herein. If the user is already a member and has registered previously, the user merely enters his or her username (identification code) and password as depicted respectively at blocks 444 and 446 to access his or her user profile and begin activating the method and system described herein to achieve particular user-defined investor goals, such as investor-matching and investor queries.

Those skilled in the art will appreciate that the icons depicted at blocks 452, 454, 455, 456, 458, 459, and 460 represent top-level navigation icons or buttons that displayed generally on most web pages of the web-based site described herein. Such top-level navigation icons are displayed in this manner to provide a consistent level of support to the user through his or her web-based site navigation. Thus, in FIGS. 11 to 17, analogous parts are indicated by like reference numerals.

FIG. 12 depicts a pictorial diagram 451 illustrating an entrepreneur homepage, in accordance with a preferred embodiment of the present invention. When a user clicks icon 454, for example, the user may be linked to the web page described in FIG. 11. The entrepreneur homepage depicted in FIG. 12 enables a user (i.e., entrepreneur) to view his or her current investor matches along with appropriate investor correspondence and contact information. A header 462 indicating the word “Legend” followed by various pictorial representations describe matches and actions that have taken place, such as investor matches, mail received from an investor, and an investor or entrepreneur match, as indicated respectively by icons 472, 474, 476, and 478. By clicking link 466, a user may be linked to a page wherein business information may be provided or updated. Clicking link 466 permits a user to enter and/or update business information, thereby initiates processing of the operation depicted at block 138 of FIG. 6. Access to a user private folder may be initiated when the user clicks hyperlink 468, thereby initiating process of the operation depicted at block 154 of FIG. 6. The user may also update his or her password information by clicking icon 470. Matches can be accessed by clicking icons displayed below header 480. For example, such icons may include a symbolic representation of a mailbox to indicate that the entrepreneur can receive e-mail. By clicking such a symbolic representation, the entrepreneur may access mail sent by interested investors or other parties. The web-based site privacy policy can be accessed by selecting hyperlink 505. Additionally, the user must agree to abide by the terms and conditions offered by the administrators of the web-based site. Selecting hyperlink 507 links users to a page outlining such terms and conditions.

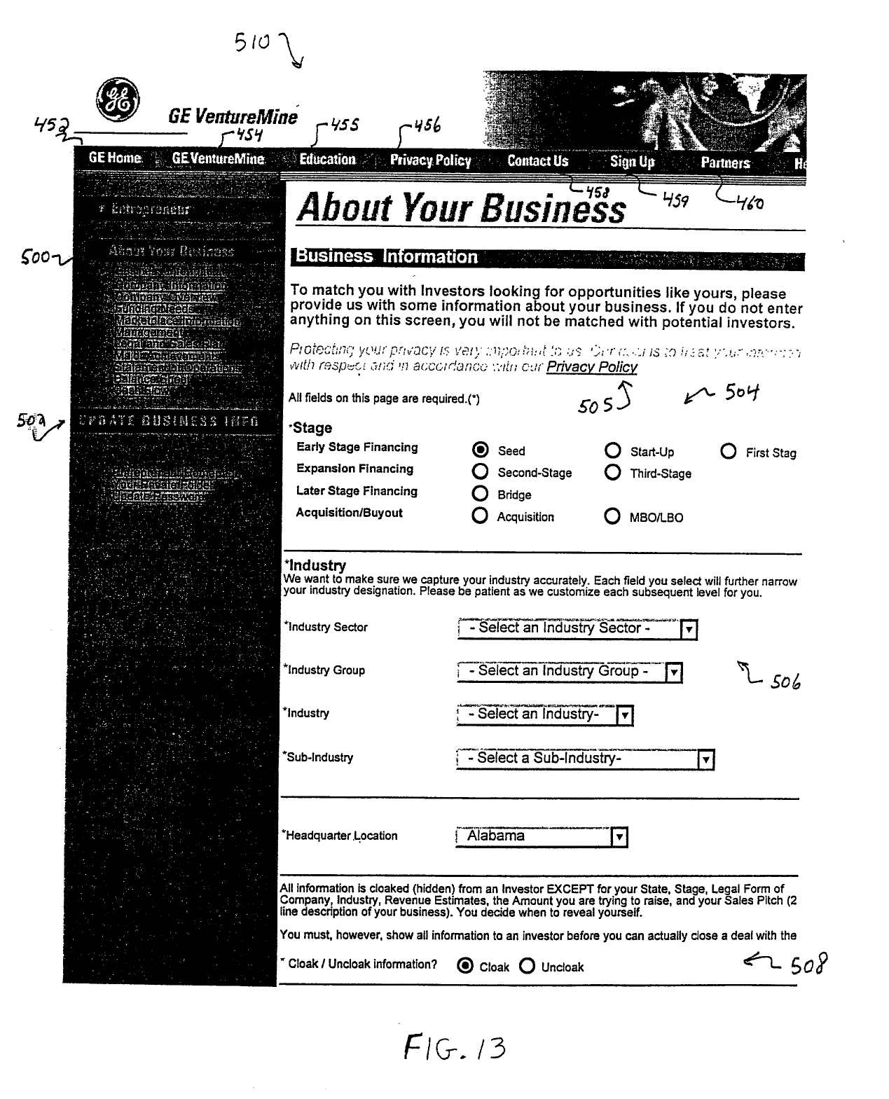

FIG. 13 illustrates a pictorial diagram 510 illustrating example user input fields for collecting particular entrepreneur data, in accordance with a preferred embodiment of the present invention. Heading 500 labeled “About Your Business” illustrates a variety of information that can be input by a user to provide entrepreneur data for compiling an entrepreneur profile and initiating investor matching, according to the method and system described herein. Hyperlinks to pages requesting business information, company information, funding needs, marketplace information, management, legal and sales plans, major achievements, statement of operations, balance sheets, and cash flow are positioned below heading 500. Pictorial diagram 510 contains portions of fields requiring user input for collecting “business information.” Radio buttons 504 can be selected by the user to indicate a need for “Early Stage Financing,” “Expansion Financing,” “Later Stage Financing,” “Acquisition/Buy Out”, and so forth.

Drop down menus 506, when activated by a user, provide industry sector, industry group, sub-industry information and so forth. Radio buttons 508 permit a user to indicate whether he or she desires the information submitted to be cloaked or uncloaked. All cloaked information may be hidden from the investor except for particular information, such as State location, Stage, Legal Form of Company, Industry, Revenue Estimates, and so forth. The user may access hyperlinks positioned below heading 502 to view matches, access homepages, and update private folders and passwords. A hyperlink 505 permits a user to access the same page associated with icon 456.

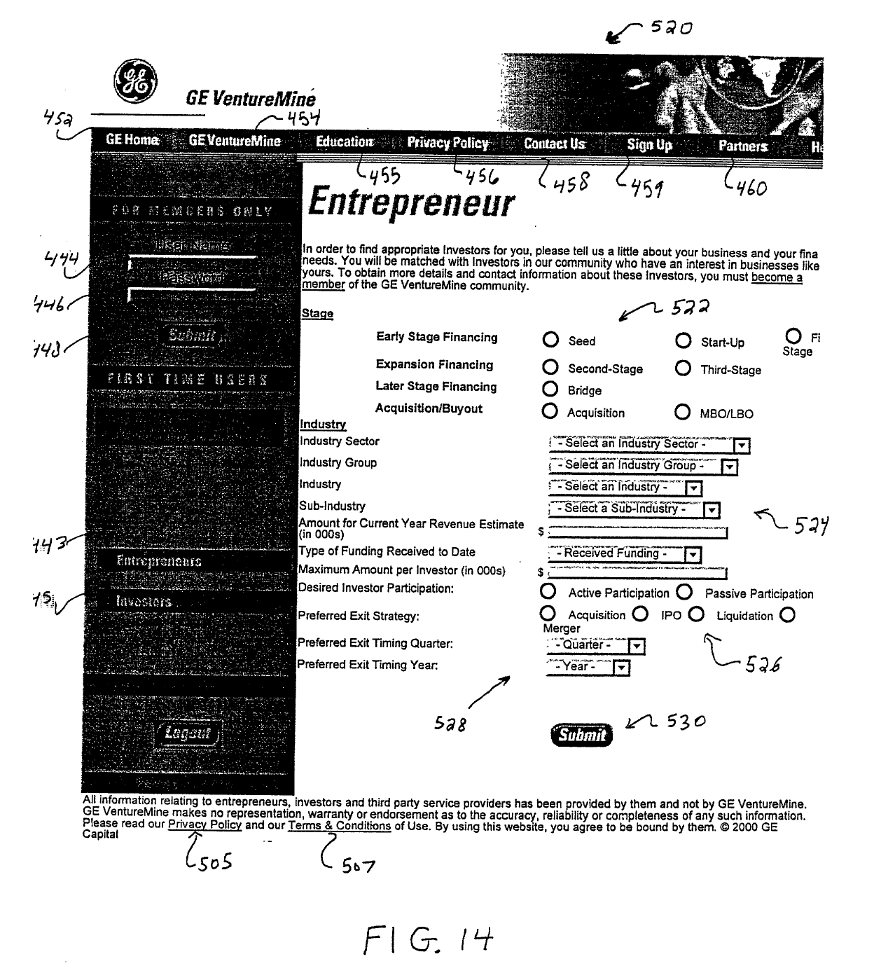

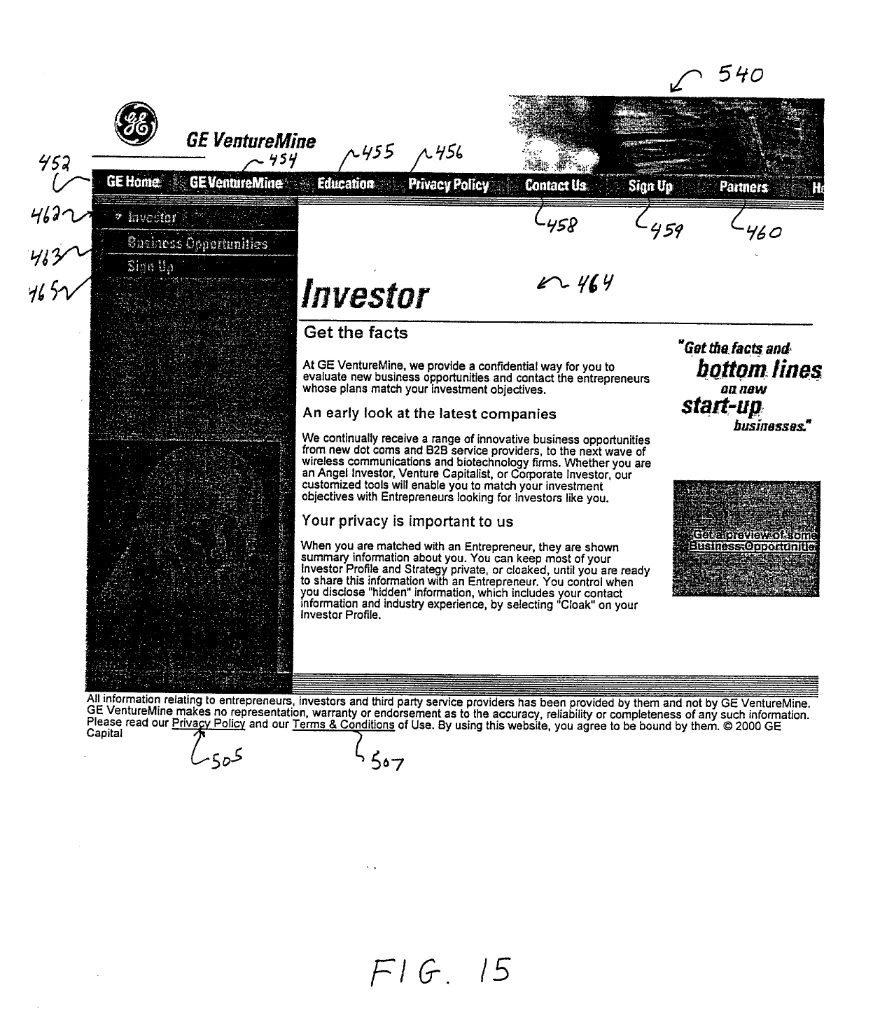

FIG. 14 depicts a pictorial diagram 520 illustrating an entrepreneur-based Quick Match section that can be displayed within a web browser window, in accordance with a preferred embodiment of the present invention. As described earlier, Quick Match may be a preliminary searching tool that provides a basic understanding to a user of how investors and entrepreneurs are matched utilizing the web-based site described herein. The user first must fill out a brief form describing his or her business and the type of funding sought.

The user then runs a Quick Match to determine how many investors are generally interested in his or her business model. The effects on the number of matches will vary, depending on user modifications to search criteria. Once the user becomes a registered member, the user can perform a Detailed Match to receive all relevant investor information and thereby initiate the deal making process with potential investors.

Radio buttons 522 permit a user to enter search criteria related to financing stages, while drop down menus 524 permit a user to select search criteria related to industry sectors, groups, and so forth. Radio buttons 526 permit a user to select investor participation and exit strategy criteria, while preferred exit timing criteria can be selected by the user via drop down menus 528. The user selects icon 530 when he or she is ready to submit the search criteria.

FIG. 15 illustrates a pictorial diagram 540 illustrating an investor page, in accordance with a preferred embodiment of the present invention. Heading 462 labeled “investor” lies above links 463 and 465. Link 463 initiates the Business Opportunity Search module and subroutines or routines thereof. Link 465 takes the investor to a web page that permits the investor to sign up for the financing and matching services offered through the web-based site described herein. Investor information 464 is displayed within the web page indicated in FIG. 15.

Introductory investor information is thus displayed within the web page illustrated in FIG. 15. The introductory investor information indicates that when an investor is matched with an entrepreneur, the entrepreneur may be provided with summary information about an investor. The investor can keep his or her investor profile and strategy private (i.e. “cloaked”) until he or she is ready to share this information with an entrepreneur. The introductory investor information further indicates that an investor can control when to disclose “hidden” information, including investor contact information and industry experience, by selecting a “cloak” feature on a particular investor profile.

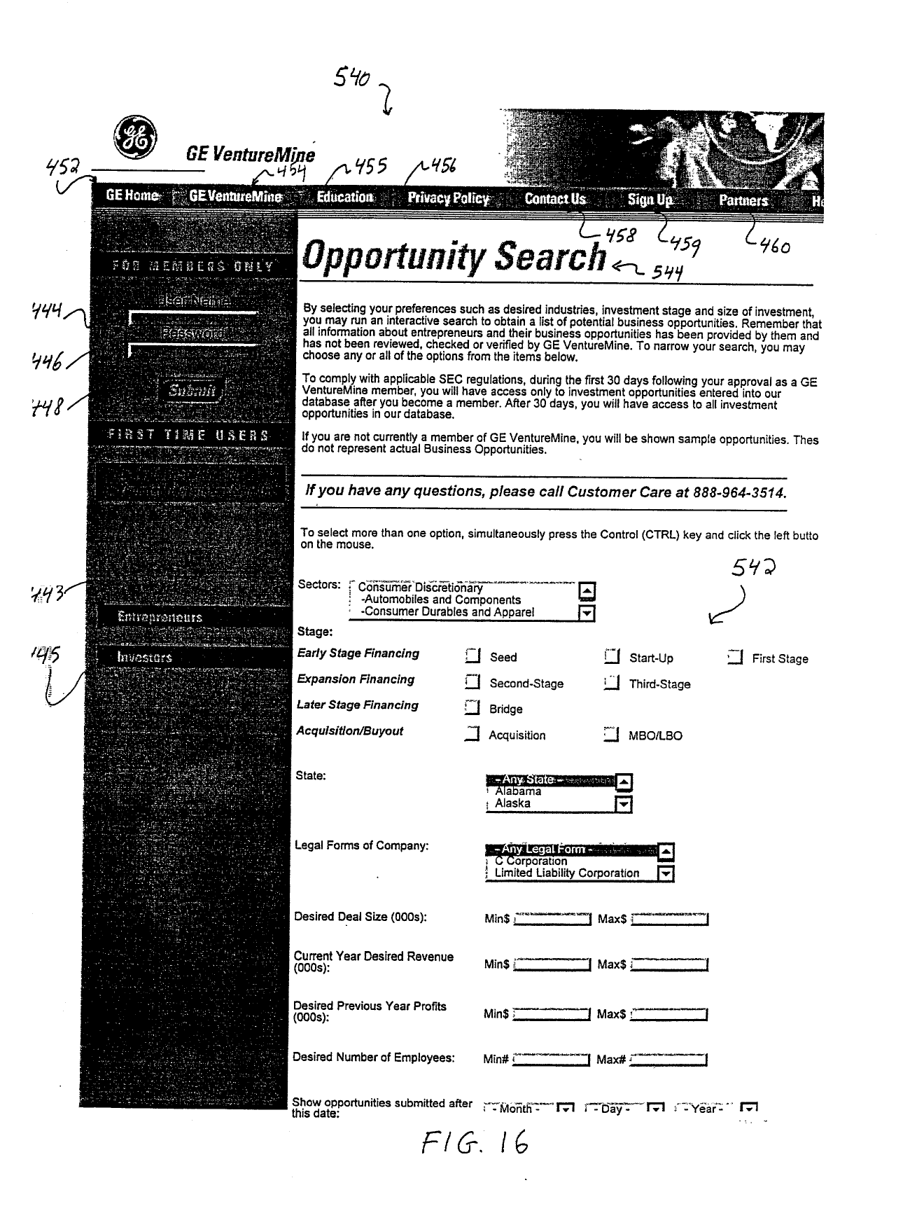

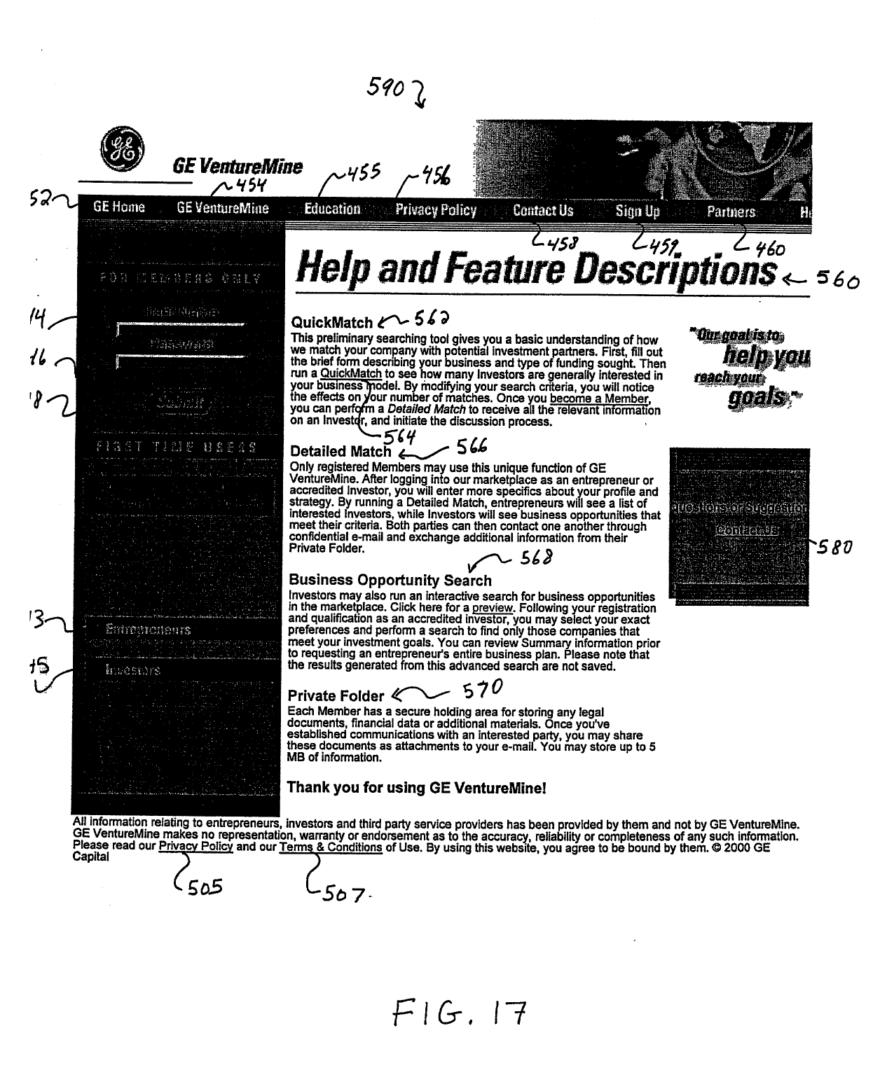

FIG. 16 depicts a pictorial diagram 540 illustrating a investor business opportunity search page, in accordance with a preferred embodiment of the present invention. Pictorial diagram 549 represents portions of a page wherein an investor may initiate a Business Opportunity Search. By selecting preferences, such as desired industries, investment stage and size of investment, the investor may run an interactive search to obtain a list of potential business opportunities. To narrow a search, an investor can utilize search criteria selection icons 542 which are composed of radio buttons and drop down fields. Icons 542 and additional investor information may be provided below heading 544 labeled “Opportunity Search.”

FIG. 17 illustrates a pictorial diagram 590 illustrating a page having help and feature descriptions for a web-based site, in accordance with a preferred embodiment of the present invention. Below heading 560 labeled “Help and Feature Descriptions,” several categories are displayed providing textual information to assist users in navigating through the web-based site described herein, and implemented in accordance with a preferred embodiment of the present invention. The Quick Match feature of the web-base site may be described below heading 562 labeled “Quick Match”. By clicking hyperlink 564, a user may access the Quick Match module to initiate a preliminary search. Information below heading 566 labeled “Detailed Match” describes the Detailed Match feature of the web-based site. Below heading 568 labeled “Business Opportunity Search,” basic information about the Business Opportunity Search module of the web-based site may be provided. Information below heading 570 labeled “Private Folder” describes the private folder and holding area features of the web-based site. A user may contact appropriate personnel utilizing hyperlink 580 which links to a page wherein e-mail may be forwarded to web-based site administrators.

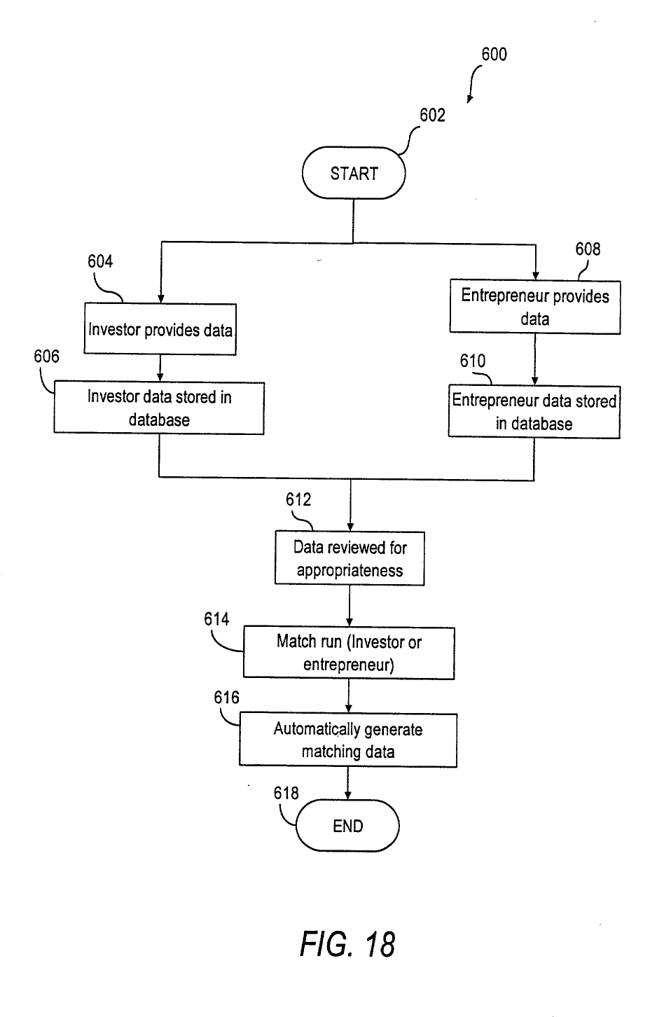

FIG. 18 depicts a high-level flow chart of operations 600 illustrating steps for implementing a method for interactively enabling venture matching, in accordance with a preferred embodiment of the present invention. Those skilled in the art can appreciate that flow chart of operations 600 illustrated in FIG. 18 represents an example methodology utilized to implement a preferred embodiment of the present invention. Other methodology and operational flow charts may also be utilized to implement the method, system and program product of the present invention.

The process is thus initiated, as indicated at block 602. Thereafter, two possible operational paths may be followed, depending on whether a user is an entrepreneur seeking investors, or an investor seeking entrepreneurial businesses in which to invest. As illustrated at block 604, an investor provides particular investor data through the web-based site described herein. The data is stored in a database, as indicated at block 606. Investor data may be reviewed against investor approval guidelines and SEC regulations. If the user is entrepreneur, then as indicated at block 608, the entrepreneur provides entrepreneur data through the web-based site. As illustrated at block 610, the data is also stored in the database. As indicated at block 612, the investor-provided data and entrepreneur-provided data are reviewed for appropriateness. For example, data that is not of an appropriate nature will not be accepted. Assuming appropriate data is approved, then as indicated at block 614, an investor or entrepreneur may run a match to identify respective entrepreneurs or investors. Matching data is then automatically generated, as depicted at block 616. The process then ends, as indicated at block 618.

Matching occurs according to specified matching rules. These matching rules can be divided into entrepreneur and investor matching rules. According to such rules, an approved entrepreneur may be defined as an entrepreneur that has been approved by a customer care resource representative at least once. Approved entrepreneurs may include those entrepreneurs who require re-approval after altering his or her profile. A pre-approved entrepreneur can be defined as entrepreneur whom has never been approved by a customer care resource representative. Both pre- and post-approved entrepreneurs may run a match. Preferably, however, only approved entrepreneurs may run a match. Matches are generally only run against approved investors.

A 30 day rule may be implemented in which approved entrepreneurs can always run a match, but can only match with investors satisfying the 30 day rule. This 30 days rule is based on the approval date of the investors and/or entrepreneurs. If the investors or entrepreneurs alter information sending them back to a work queue, the 30 day rule is still based on the original approval date.

Other matching rules are based on the stage of a business. That is, an entrepreneur's business stage can be matched with an investor's strategy stage. Matching rules based on industry may also be implemented in which an entrepreneur's business industry is watched with an investor's strategy sectors selections. Deal size rules may also be utilized. For example, a rule may be implemented in which a determination is made whether or not an entrepreneur's maximum amount of business investment per investor is greater than an investor's strategic minimum amount for investment or less than an investor's strategic maximum amount for investment. Additional rules include the legal form of company, region, type of funding received to date, preferred exit strategy and time, and specified investor participation information. Additional rules are based on information related to the management team, market size, market growth rates, revenue, EBITDA margins, gross margins, and profitability timing.

Likewise, investor matching rules are based on stage, industry, deal size, legal form of company, region, type of funding received to date, and preferred exit strategy and time. Additional investor matching rules can be based on investor participation, management team, market size, market growth rates, revenue, EBITDA margins, gross margins, and profitability timing. An approved investor may be defined as investor whom has been approved by a customer care representative at least once. This includes those investors who require re-approval after changing their application information. A pre-approved investor may be defined as an investor who has never been approved by a customer care representative. Only approved investors may run a match. Matches are generally run only against approved entrepreneurs.

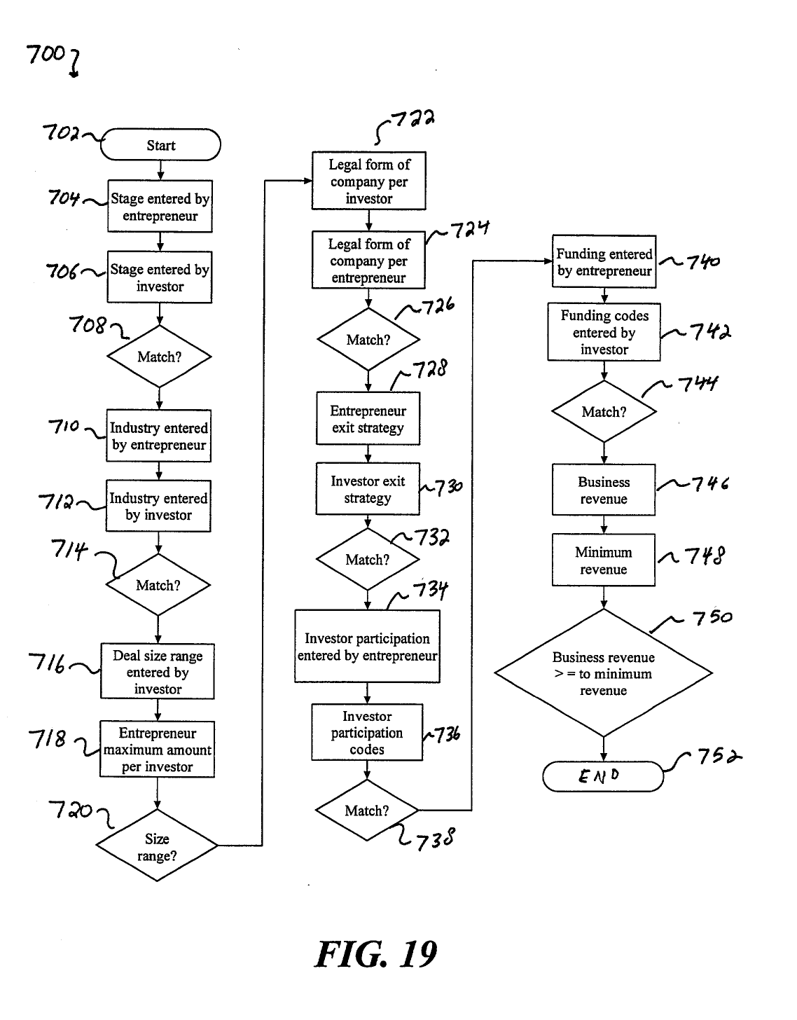

FIG. 19 illustrates a flow chart 700 of operations illustrating high-level venture matching operations, in accordance with a preferred embodiment of the present invention. The process may be initiated, as illustrated at block 702. As indicated at block 704, a stage may be entered by an entrepreneur through a web-based site, such as the web-based site discussed herein. As depicted at block 706, one or more stages is entered by an investor who may represents a venture financing organization.

As indicated next at block 708, it is determined if a match takes place between a stage entered by the entrepreneur and one of the stages entered by the investor. If so, matching criteria is generated. As illustrated at block 710, the entrepreneur provides industry data. Thereafter, as indicated at block 712, the investor enters industry data as part of his or her investment strategy. If a match may be determined, as indicated at block 714, matching industry data may be generated as matching criteria for establishing an investor/entrepreneur match.

As illustrated at block 716, an investor enters a deal size range as part of his or investment strategy. As depicted at block 718, the entrepreneur enters a maximum amount per investor. As described next at block 720, it may be then determined if the entrepreneur's maximum amount per investor is within the deal size range entered by the investor as part of his or her investment strategy. If so, then matching criteria may be generated and the process continues.

As depicted at block 722, the investor enters a particular Legal Form of Company as part of his or investment strategy. Similarly, as described at block 724, the entrepreneur enters a particular Legal Form of Company. For example, if the Legal Form of Company may be a Limited Liability Corporation, the entrepreneur and investor must indicate so. An appropriate match may be then determined, as indicated at block 726.

The entrepreneur then enters exit strategy data, as illustrated at block 730. Similarly, the investor enters his or her own exit strategy data, as indicated at block 730. A match takes place, as depicted at block 732, if the entrepreneur exit strategy data may be the same as one of the investor's strategies entered as part of his or her investment profile AND the entrepreneur's timing is less than the indicated investor timing. If, however, the entrepreneur selects “Stay Private Long Term,” then all matches are rendered FALSE.

Investor participation data may be entered by the entrepreneur, as indicated at block 724. As depicted at block 736, investor participation codes are entered. Then, as illustrated at block 738, a match takes place if investor participation data entered the entrepreneur matches of the investor participation codes entered by the investor as part of his or investment strategy.

Funding data may also be entered by the entrepreneur, as depicted at block 740. Funding codes are entered by the investor, as illustrated at block 742. A match takes place, as indicated at block 744, if data indicative of “Funding Received to Date” entered by the entrepreneur matches one of the previous funding codes entered by the investor as part of his or investment strategy. As illustrated at block 746, business revenue data may be entered by the entrepreneur. As indicated at block 748, minimum revenue data may be provided by the investor. A revenue match may then take place, as depicted at block 750, if the business revenue is greater than or equal to the minimum revenue required by the investor.

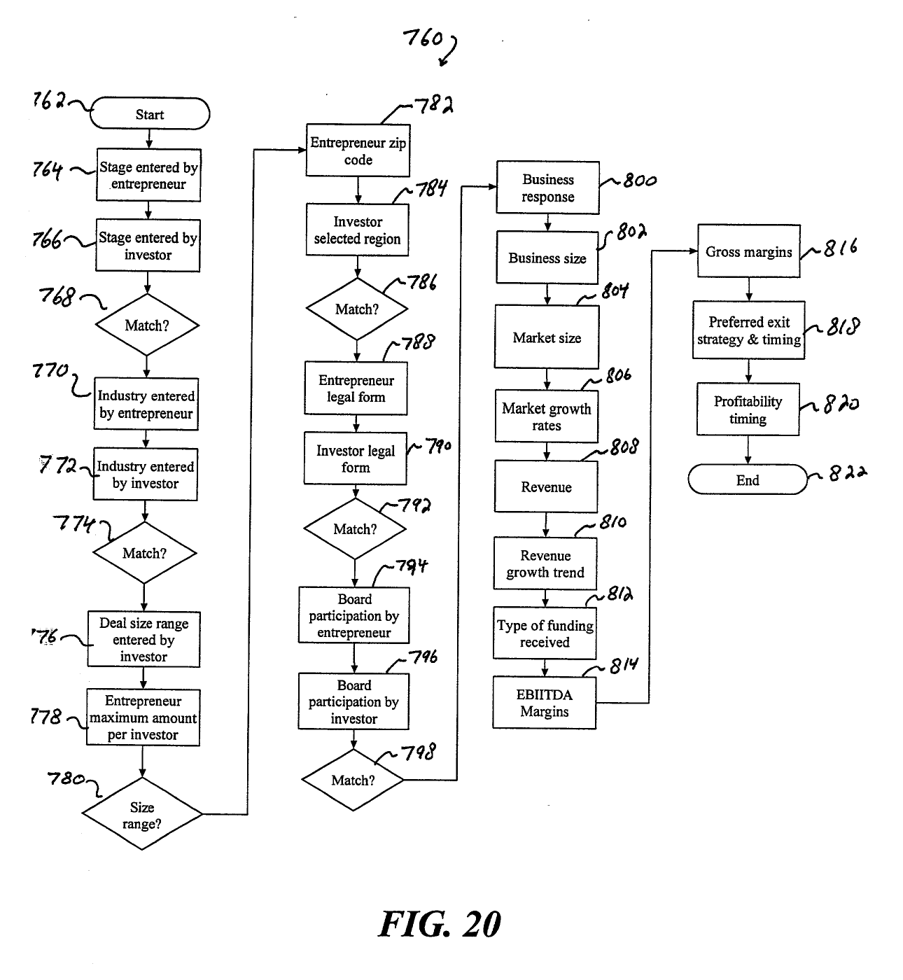

FIG. 20 depicts of a flow chart 760 of operations illustrating detailed venture matching operations, in accordance with a preferred embodiment of the present invention. The process may be initiated, as illustrated at block 762. As indicated at block 764, a stage may be entered by an entrepreneur through a web-based site, such as the web-based site discussed herein. As depicted at block 766, one or more stages may be entered by an investor who may represent a venture financing organization.

As indicated next at block 768, it is determined if a match takes place between a stage entered by the entrepreneur and one of the stages entered by the investor. If so, matching criteria may be generated. As illustrated at block 770, the entrepreneur provides industry data. Thereafter, as indicated at block 772, the investor enters industry data as part of his or her investment strategy. If a match is determined, as indicated at block 774, matching industry data may be generated as matching criteria for establishing an investor/entrepreneur match.

As illustrated at block 776, an investor enters a deal size range as part of his or investment strategy. As depicted at block 778, the entrepreneur enters a maximum amount per investor. As described next at block 780, it may be then determined if the entrepreneur's maximum amount per investor is within the deal size range entered by the investor as part of his or her investment strategy. If so, then matching criteria may be generated and the process continues.

As illustrated at block 782, the entrepreneur provides geographical information in the form of zip code data. The investor provides a selected region, as indicated at block 784. A regional preference match can then take place if the zip code of the entrepreneur's address matches with one of the states or regions the investor has selected as being preferable, as indicated by decision block 786.

As indicated at block 788, the entrepreneur may enter a Legal Form of Company. Similarly, as illustrated at block 790, the investor may enter his or her preferred Legal Form of Company. A match takes place, as depicted at block 792, if the Legal Form of Company entered by the Entrepreneur matches one of the Legal Forms of Companies entered by the investor as part of his or her investment strategy.

As illustrated at block 794, the entrepreneur enters board participation data. Similarly, as depicted at block 796, the investor may enter board participation data. A match takes place if board participation data entered by the entrepreneur matches one of the board participation codes entered by the investor as part of his her investment strategy.

Note that the operational steps described in blocks 800 to 822 have been abbreviated for the sake of simplicity. Those skilled in the art can appreciate that a similar matching and decision making process may occur thereof. Thus, as illustrated at block 800, a management team match occurs if a “business response” contains names of management team members checked in particular positions by an investor via a web-based site form. As illustrated at block 802, business size data may be entered by the entrepreneur.

As depicted at block 804, a market size match may occur if the business plan size of a particular industry (i.e., business size data) may be greater than or equal to a range indicated by the investor in an investor response. As depicted next at block 806, a market growth rate match may take place if an indicated business plan industry growth rate may be greater than or equal to the range indicated in the investor response. A revenue match may take place thereafter, as indicated at block 808, if the business revenue is greater than or equal to a minimum revenue required by the investor.

As illustrated at block 810, a revenue growth trend match may take place if a revenue growth rate calculated from the entrepreneur business plan may be greater than or equal to a range indicated in the investor response. As depicted at block 812, the “type of funding received to date” may be matched if acceptable forms “Funding Received to Date” entered as part of an investment strategy by the investor may be equivalent to “Funding Received to Date” codes entered by the entrepreneur.

Next, as illustrated at block 814, EBITDA Margin matching may take place if the EBITDA calculated, based on Income Statement data entered by the business of the entrepreneur may be greater than the percent for the Investment Strategy entered by the investor. As depicted thereafter at block 816, a “gross margins” match may take place if gross margins calculated based on the Income Statement information entered by the entrepreneur may be greater than the percent for the investment strategy entered by the investor.

Thereafter, as described at block 818, “Preferred Exit Strategy Timing” matching takes place if the entrepreneur strategy is equivalent to one of the investor's strategies entered as part of an investment portfolio AND the entrepreneur's timing is less than the investor's timing. Finally, as indicated at block 820, profitability timing is matched based on estimated times for business profitability. The process thereafter is terminated, as indicated at block 822. Those skilled in the art will appreciate that FIG. 20 represents merely one type of flow chart that may be followed to implement the method, system, and program product described herein. Other types of operational flow diagrams may also be utilized to implement the present invention.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. For example, the web-based site illustrated herein refers to the web-based site as “GE VentureMine.” The phrase “GE VentureMine” is utilized for illustrative purposes only and is not to be construed as limiting terminology. Those skilled in the art can also appreciate that the present invention can be utilize not only in the financial industries and arts, but a wide variety of other industries wherein users may be matched with other users to close a deal or initiate joint ventures and discussions.

Thus, the description as set forth herein is not intended to be exhaustive or to limit the invention to the precise form disclosed. Many modifications and variations are possible in light of the above teaching without departing from the spirit and scope of the following claims.

1. A method in a computer network for interactively matching entrepreneurs with investors based on user-provided data, wherein said computer network has at least one client connectable to one or more servers, said method comprising the steps of:
designating a database wherein investor-provided data and entrepreneur-provided data are stored;
analyzing entrepreneur-provided data; and
matching entrepreneur-provided data with investor-provided data based on a set of predetermined matching criteria, thereby enabling entrepreneurs to match with appropriate investors through a web-based site.

2. The method of claim 1 further comprising the step of:
matching entrepreneur-provided data with investor-provided data based on a set of predetermined matching criteria, in response to analyzing said entrepreneur-provide data.

3. The method of claim 1 further comprising the step of:
matching entrepreneur-provided data with investor-provided data based on a set of predetermined matching criteria, in response to analyzing said investor-provided data and said entrepreneur-provided data.

4. The method of claim 1 further comprising the step of:
storing said entrepreneur-provided data within said database.

5. The method of claim 4 further comprising the step of:
associating said database with said web-based site.

6. The method of claim 1 further comprising the step of:
prompting said entrepreneur to input entrepreneur-provided data to said web-based site.

7. The method of claim 6 further comprising the step of:
prompting said investor to input investor-provided data to said web-based site.

8. The method of claim 7 further comprising the step of:
configuring said predetermined matching criteria with investor and entrepreneur business criteria.

9. The method of claim 1 further comprising the step of configuring said predetermined matching criteria with at least one of the following matching criteria:
stage information;
industry information;
deal size information;
geographic information;
legal information;
board information;
market size information;
revenue information;
funding information;
margin information; and
profitability information.

10. The method of claim 1 further comprising the step of:
rendering matching information within said web-based site, in response to matching entrepreneur-provided data with investor-provided data based on a set of predetermined matching criteria.

11. A system in a computer network for interactively matching entrepreneurs with investors based on user-provided data, wherein said computer network has at least one client connectable to one or more servers, said system comprising:
database wherein investor-provided data and entrepreneur provide data are stored;
module for analyzing entrepreneur-provided data; and
module for matching entrepreneur-provided data with investor-provided data based on a set of predetermined matching criteria, thereby enabling entrepreneurs to match with appropriate investors through a web-based site.

12. The system of claim 11 further comprising:
module for matching entrepreneur-provided data with investor-provided data based on a set of predetermined matching criteria, in response to analyzing said entrepreneur-provide data.

13. The system of claim 11 further comprising:
module for matching entrepreneur-provided data with investor-provided data based on a set of predetermined matching criteria, in response to analyzing said investor-provided data and said entrepreneur-provided data.

14. The system of claim 13 further comprising:
module for storing said entrepreneur-provided data within said database.

15. The system of claim 14 further comprising:
module for associating said database with said web-based site.

16. The system of claim 11 further comprising:
module for prompting said entrepreneur to input entrepreneur-provided data to said web-based site.

17. The system of claim 16 further comprising:
module for prompting said investor to input investor-provided data to said web-based site.

18. The system of claim 17 further comprising:
module for configuring said predetermined matching criteria with investor and entrepreneur business criteria.

19. The system of claim 11 further comprising:
module for configuring said predetermined matching criteria with at least one of the following matching criteria:
stage information;
industry information;
deal size information;
geographic information;
legal information;
board information;
market size information;
revenue information;
funding information;
margin information; and
profitability information.

20. The system of claim 11 further comprising:
module for rendering matching information within said web-based site, in response to matching entrepreneur-provided data with investor-provided data based on a set of predetermined matching criteria.

21. A program product residing in computer memory in a computer network for interactively matching entrepreneurs with investors based on user-provided data, wherein said computer network has at least one client connectable to one or more servers, said program product comprising:
database wherein investor-provided data and entrepreneur provide data are stored;
analyzing module residing in computer memory for analyzing entrepreneur-provided data; and
matching module residing in computer memory for matching entrepreneur-provided data with investor-provided data based on a set of predetermined matching criteria, thereby enabling entrepreneurs to match with appropriate investors through a web-based site.

22. The program product of claim 21 further comprising:
matching module residing in computer memory for matching entrepreneur-provided data with investor-provided data based on a set of predetermined matching criteria, in response to analyzing said entrepreneur-provide data.

23. The program product of claim 21 further comprising:
matching module residing in computer memory for matching entrepreneur-provided data with investor-provided data based on a set of predetermined matching criteria, in response to analyzing said investor-provided data and said entrepreneur-provided data.

24. The program product of claim 23 further comprising:
storage module residing in computer memory for storing said entrepreneur-provided data.

25. The program product of claim 24 further comprising:
associating module residing in computer memory for associating said database with said web-based site.

26. The program product of claim 21 further comprising:
prompting module residing in computer memory for prompting said entrepreneur to input entrepreneur-provided data to said web-based site.

27. The program product of claim 26 further comprising:
prompting module residing in computer memory for prompting said investor to input investor-provided data to said web-based site.

28. The program product of claim 27 further comprising:
configuring module residing in computer memory for configuring said predetermined matching criteria with investor and entrepreneur business criteria.

29. The program product of claim 21 further comprising:
configuring module residing in computer memory for configuring said predetermined matching criteria with at least one of the following matching criteria:
stage information;
industry information;
deal size information;
geographic information;
legal information;
board information;
market size information;
revenue information;
funding information;
margin information; and
profitability information.

30. The program product of claim 21 further comprising:
rendering module residing in computer memory for rendering matching information within said web-based site, in response to matching entrepreneur-provided data with investor-provided data based on a set of predetermined matching criteria.

31. The program product of claim 21 wherein each of said modules further comprise signal-bearing media.

32. The program product of claim 31 wherein said signal-bearing media comprises transmission media.

33. The program product of claim 31 wherein said signal-bearing medial comprises recordable media.

34. The program product of claim 31 further comprising a control program within a main memory of a computer linked to a computer network through a communications adapter.
